(19) United States
(12) Patent Application Publication
(10) Pub. No.: US 2024/0060405 A1
(43) Pub. Date: Feb. 22, 2024

(54) METHOD AND SYSTEM FOR GENERATING PREDICTIVE LOGIC AND QUERY REASONING IN KNOWLEDGE GRAPHS FOR PETROLEUM SYSTEMS

(71) Applicant: SAUDI ARABIAN OIL COMPANY, Dhahran (SA)

(72) Inventors: Marko Maucec, Englewood, CO (US); Suha Naim Kayum, Dhahran (SA)

(73) Assignee: SAUDI ARABIAN OIL COMPANY, Dhahran (SA)

(21) Appl. No.: 17/821,409

(22) Filed: Aug. 22, 2022

(51) Int. Cl. E21B 43/25; E21B 49/08; G06N 7/00

(52) U.S. Cl. CPC E21B 43/25; E21B 49/087; G06N 7/00

(57) ABSTRACT

A method for reservoir simulation involves examining a knowledge graph logic associated with a reservoir simulation model for completeness. The knowledge graph logic contains decision information that governs an execution of the reservoir simulation model. The method further involves making a determination, based on the examination, that the knowledge graph logic is incomplete, based on the determination, generating an updated knowledge graph logic, obtaining the decision information from the updated knowledge graph, and executing the reservoir simulation model as instructed by the decision information.

### BACKGROUND

In the field of oil and gas energy field development and production optimization, techniques for efficiently gathering natural resources are of great importance for maximizing production while minimizing environmental impact and risks. Reservoir simulation models may be used to assess the current state of a petroleum system and/or to predict a state in the future.

The calibration of reservoir simulation models to dynamic field production data, commonly referred to as history matching (HM), is perceived as one of the most time consuming and computationally intensive engineering processes in reservoir validation. The task of dynamic model reconciliation becomes even more challenging in the presence of reservoir structural complexities (e.g. fractures) and intrinsic subsurface uncertainty. Additionally, the subsequent step of optimum field development planning (prediction) is even more complex, as it involves several variables. Reservoir field depletion strategy (natural depletion, water injection, gas injection, etc.), well types and orientation, well count, well and field level operations are a few amongst the many variables.

In view of these and other complexities, it may be desirable to have systems and methods that facilitate the operations involved in reservoir simulation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method for reservoir simulation, the method comprising: examining a knowledge graph logic associated with a reservoir simulation model for completeness, wherein the knowledge graph logic comprises decision information that governs an execution of the reservoir simulation model; making a determination, based on the examination, that the knowledge graph logic is incomplete; based on the determination, generating an updated knowledge graph logic; obtaining the decision information from the updated knowledge graph; and executing the reservoir simulation model as instructed by the decision information.

In general, in one aspect, embodiments relate to a non-transitory machine-readable medium comprising a plurality of machine-readable instructions executed by one or more processors, the plurality of machine-readable instructions causing the one or more processors to perform operations comprising: examining a knowledge graph logic associated with a reservoir simulation model for completeness, wherein the knowledge graph logic comprises decision information that governs an execution of the reservoir simulation model; making a determination, based on the examination, that the knowledge graph logic is incomplete; based on the determination, generating an updated knowledge graph logic; obtaining the decision information from the updated knowledge graph; and executing the reservoir simulation model as instructed by the decision information.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a drilling system in accordance with one or more embodiments of the disclosure.

FIG. 2 shows a block diagram with an example of a system using categories of inputs to update petroleum systems (PEs), in accordance with one or more embodiments of the disclosure.

FIG. 3A shows a block diagram with an example of layers within a representation learning to massive petroleum engineering system (ReLMaPS), in accordance with one or more embodiments of the disclosure.

FIG. 3B shows a screenshot showing an example of a user interface for a well productivity performance recommendation system, in accordance with one or more embodiments of the disclosure.

FIG. 4 shows a graph showing an example of a topological ordering of directed acyclic graphs (DAGs), in accordance with one or more embodiments of the disclosure.

FIG. 5 shows a network diagram of an example of a network for the ontological framework (OF)/DAG corresponding to the process of well flow rate estimation, in accordance with one or more embodiments of the disclosure.

FIG. 6 shows a network diagram of an example of a network for the OF/DAG corresponding to the process of estimation of ultimate recovery (EUR), in accordance with one or more embodiments of the disclosure.

FIG. 7 shows a network diagram of an example of a network for the OF/DAG corresponding to the process of dynamic calibration of a reservoir simulation model, in accordance with one or more embodiments of the disclosure.

FIG. 8 shows a flowchart of an example of a process for building a knowledge discovery engine, in accordance with one or more embodiments of the disclosure.

FIG. 9A shows a network diagram showing an example of a computation graph corresponding to a specific task of PE systems data representation learning, in accordance with one or more embodiments of the disclosure.

FIG. 9B shows a network diagram showing an example of a network showing aggregations, in accordance with one or more embodiments of the disclosure.

FIG. 10 shows an example of a computation graph corresponding to an example of graph representation learning process for well rate estimation, in accordance with one or more embodiments of the disclosure.

FIG. 11 shows a flowchart of an example of a smart agent process for well inflow performance relationship/vertical lift performance (IPR/VLP) performance, in accordance with one or more embodiments of the disclosure.

FIG. 12 shows a flowchart of an example of a smart agent process for quick production performance diagnostics (QPPD), in accordance with one or more embodiments of the disclosure.

FIG. 13 shows a flowchart of a smart agent process for computer-assisted history matching (AHM), in accordance with one or more embodiments of the disclosure.

FIG. 14 shows a flowchart of a smart agent process for injection allocation optimization (IAO), in accordance with one or more embodiments of the disclosure.

FIG. 15 shows a flowchart of a smart agent process for artificial lift optimization (ALO), in accordance with one or more embodiments of the disclosure.

FIG. 16 shows a flowchart of a smart agent process for probabilistic scenario analysis (PSA), in accordance with one or more embodiments of the disclosure.

FIG. 17 shows a flowchart of a method for providing recommendations and advisories using OFs generated from aggregated data received from disparate data sources, in accordance with one or more embodiments of the disclosure.

FIG. 18 shows a flowchart of a method for using aggregation functions to aggregate information for nodes in ontological frameworks, in accordance with one or more embodiments of the disclosure.

FIG. 19 shows a flowchart of a method for history matching and making recommendations for field development, in accordance with one or more embodiments of the disclosure.

FIG. 20 shows a flowchart of a method for updating a knowledge graph logic, in accordance with one or more embodiments of the disclosure.

FIG. 21 shows a flowchart of a method for updating the KG logic, in accordance with one or more embodiments of the disclosure.

FIG. 22A-22F show examples of a knowledge graph and reasoning/decisions making, in accordance with one or more embodiments of the disclosure.

FIGS. 23A and 23B show examples of a sensitivity analysis, in accordance with one or more embodiments of the disclosure.

FIG. 24 shows an example of improved performance of a history matching model, in accordance with one or more embodiments of the disclosure.

FIG. 25 shows a computing system, in accordance with one or more embodiments of the disclosure.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

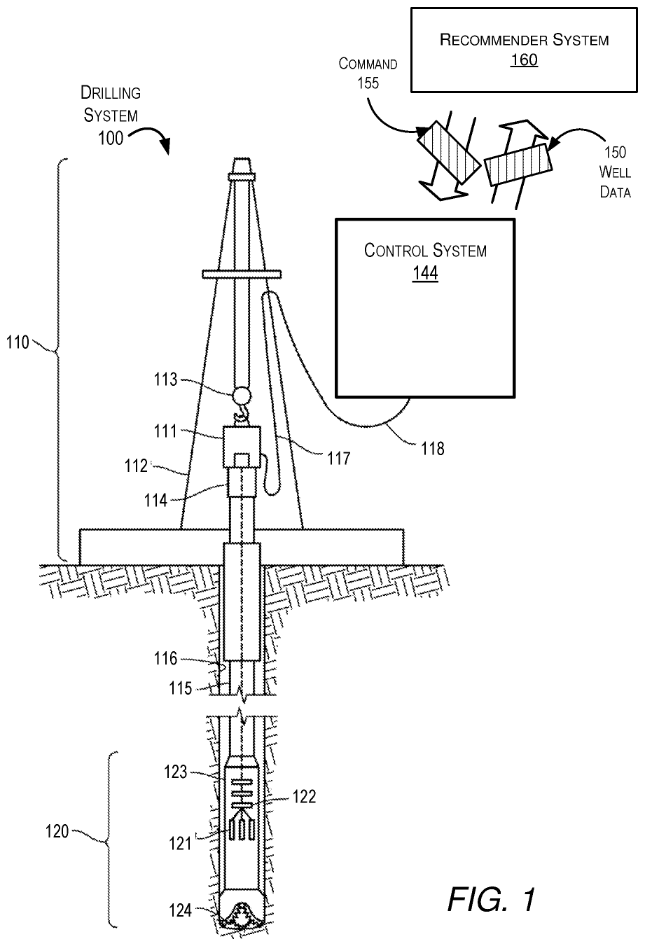

In general, embodiments of the disclosure include systems and methods for generating predictive logic and query reasoning in knowledge graphs for petroleum engineering (PE) systems. An example of a PE system is shown in FIG. 1.

FIG. 1 shows a drilling system (100) that may include a top drive drill rig (110) arranged around the setup of a drill bit logging tool (120). A top drive drill rig (110) may include a top drive (111) that may be suspended in a derrick (112) by a travelling block (113). In the center of the top drive (111), a drive shaft (114) may be coupled to a top pipe of a drill string (115), for example, by threads. The top drive (111) may rotate the drive shaft (114), so that the drill string (115) and a drill bit logging tool (120) cut the rock at the bottom of a wellbore (116). A power cable (117) supplying electric power to the top drive (111) may be protected inside one or more service loops (118) coupled to a control system (144). As such, drilling mud may be pumped into the wellbore (116) through a mud line, the drive shaft (114), and/or the drill string (115).

The control system (144) may include one or more programmable logic controllers (PLCs) that include hardware and/or software with functionality to control one or more processes performed by the drilling system (100). Specifically, a programmable logic controller may control valve states, fluid levels, pipe pressures, warning alarms, and/or pressure releases throughout a drilling rig. In particular, a programmable logic controller may be a ruggedized computer system with functionality to withstand vibrations, extreme temperatures, wet conditions, and/or dusty conditions, for example, around a drilling rig. Without loss of generality, the term “control system” may refer to a drilling operation control system that is used to operate and control the equipment, a drilling data acquisition and monitoring system that is used to acquire drilling process and equipment data and to monitor the operation of the drilling process, or a drilling interpretation software system that is used to analyze and understand drilling events and progress. For example, the control system (144) may be coupled to the sensor assembly (123) in order to perform various program functions for up-down steering and left-right steering of the drill bit (124) through the wellbore (116). While one control system is shown in FIG. 1, the drilling system (100) may include multiple control systems for managing various well drilling operations, maintenance operations, and/or well completion operations.

The wellbore (116) may include a bored hole that extends from the surface into a target zone of the hydrocarbon-bearing formation, such as the reservoir. An upper end of the wellbore (116), terminating at or near the surface, may be referred to as the “up-hole” end of the wellbore (116), and a lower end of the wellbore, terminating in the hydrocarbon-bearing formation, may be referred to as the “downhole” end of the wellbore (116). The wellbore (116) may facilitate the circulation of drilling fluids during well drilling operations, the flow of hydrocarbon production (“production”) (e.g., oil and gas) from the reservoir to the surface during production operations, the injection of substances (e.g., water) into the hydrocarbon-bearing formation or the reservoir during injection operations, or the communication of monitoring devices (e.g., logging tools) into the hydrocarbon-bearing formation or the reservoir during monitoring operations (e.g., during in situ logging operations).

As further shown in FIG. 1, sensors (121) may be included in a sensor assembly (123), which is positioned adjacent to a drill bit (124) and coupled to the drill string (115). Sensors (121) may also be coupled to a processor assembly (123) that includes a processor, memory, and an analog-to-digital converter (122) for processing sensor measurements. For example, the sensors (121) may include acoustic sensors, such as accelerometers, measurement microphones, contact microphones, and hydrophones. Likewise, the sensors (121) may include other types of sensors, such as transmitters and receivers to measure resistivity, gamma ray detectors, etc. The sensors (121) may include hardware and/or software for generating different types of well logs (such as acoustic logs or sonic logs) that may provide well data about a wellbore, including well watercut, pressure, gas to oil ratio (GOR), permeability of a geologic formation, transmissibility, pore volume, compressibility, density, porosity of wellbore sections, gas saturation, bed boundaries in a geologic formation, fractures in the wellbore or completion cement, and many other pieces of information about a formation. If such well data is acquired during well drilling operations (i.e., logging-while-drilling), then the information may be used to make adjustments to drilling operations in real-time. Such adjustments may include rate of penetration (ROP), drilling direction, altering mud weight, and many others drilling parameters.

In some embodiments, acoustic sensors may be installed in a drilling fluid circulation system of a drilling system (100) to record acoustic drilling signals in real-time. Drilling acoustic signals may transmit through the drilling fluid to be recorded by the acoustic sensors located in the drilling fluid circulation system. The recorded drilling acoustic signals may be processed and analyzed to determine well data, such as lithological and petrophysical properties of the rock formation. This well data may be used in various applications, such as steering a drill bit using geosteering, casing shoe positioning, etc.

Keeping with FIG. 1, when completing a well, one or more well completion operations may be performed prior to delivering the well to the party responsible for production or injection. Well completion operations may include casing operations, cementing operations, perforating the well, gravel packing, directional drilling, hydraulic and acid stimulation of a reservoir region, and/or installing a production tree or wellhead assembly at the wellbore (116). Likewise, well operations may include open-hole completions or cased-hole completions. For example, an open-hole completion may refer to a well that is drilled to the top of the hydrocarbon reservoir. Thus, the well is cased at the top of the reservoir, and left open at the bottom of a wellbore. In contrast, cased-hole completions may include running casing into a reservoir region. Cased-hole completions are discussed further below with respect to perforation operations.

In one well delivery example, the sides of the wellbore (116) may require support, and thus casing may be inserted into the wellbore (116) to provide such support. After a well has been drilled, casing may ensure that the wellbore (116) does not close in upon itself, while also protecting the wellstream from outside incumbents, like water or sand. Likewise, if the formation is firm, casing may include a solid string of steel pipe that is run on the well and will remain that way during the life of the well. In some embodiments, the casing includes a wire screen liner that blocks loose sand from entering the wellbore (116).

In another well delivery example, a space between the casing and the untreated sides of the wellbore (116) may be cemented to hold a casing in place. This well operation may include pumping cement slurry into the wellbore (116) to displace existing drilling fluid and fill in this space between the casing and the untreated sides of the wellbore (116). Cement slurry may include a mixture of various additives and cement. After the cement slurry is left to harden, cement may seal the wellbore (116) from non-hydrocarbons that attempt to enter the wellstream. In some embodiments, the cement slurry is forced through a lower end of the casing and into an annulus between the casing and a wall of the wellbore (116). More specifically, a cementing plug may be used for pushing the cement slurry from the casing. For example, the cementing plug may be a rubber plug used to separate cement slurry from other fluids, reducing contamination and maintaining predictable slurry performance. A displacement fluid, such as water, or an appropriately weighted drilling fluid, may be pumped into the casing above the cementing plug. This displacement fluid may be pressurized fluid that serves to urge the cementing plug downward through the casing to extrude the cement from the casing outlet and back up into the annulus.

Keeping with well operations, some embodiments include perforation operations. More specifically, a perforation operation may include perforating casing and cement at different locations in the wellbore (116) to enable hydrocarbons to enter a wellstream from the resulting holes. For example, some perforation operations include using a perforation gun at different reservoir levels to produce holed sections through the casing, cement, and sides of the wellbore (116). Hydrocarbons may then enter the wellstream through these holed sections. In some embodiments, perforation operations are performed using discharging jets or shaped explosive charges to penetrate the casing around the wellbore (116). In another well delivery, a filtration system may be installed in the wellbore (116) in order to prevent sand and other debris from entering the wellstream. For example, a gravel packing operation may be performed using a gravel-packing slurry of appropriately sized pieces of coarse sand or gravel. As such, the gravel-packing slurry may be pumped into the wellbore (116) between a casing's slotted liner and the sides of the wellbore (116). The slotted liner and the gravel pack may filter sand and other debris that might have otherwise entered the wellstream with hydrocarbons.

In another well delivery, a wellhead assembly may be installed on the wellhead of the wellbore (116). A wellhead assembly may be a production tree (also called a Christmas tree) that includes valves, gauges, and other components to provide surface control of subsurface conditions of a well.

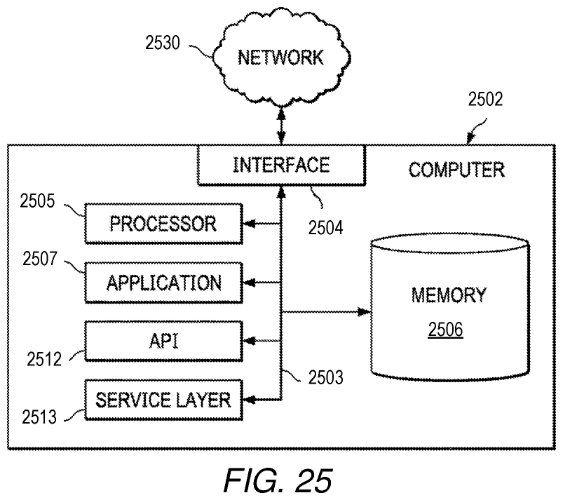

In some embodiments, a recommender system (160) is coupled to one or more control systems (e.g., control system (144)) at a wellsite. The recommender system (160) may be a computer system similar to the computer system described below in FIG. 25 and the accompanying description. The recommender system (160) may include hardware and/or software to collect well operation data (e.g., well data (150)) from one or more well sites. Based on the well operation data, the recommender system (160) may monitor the well operations. The recommender system may further initiate or recommend operations to be performed by the drilling system (100) and/or other related systems. For example, the recommender system may recommend or initiate operations that are part of a field development plan, including, but not limited to, strategies for natural depletion, water injection, gas injection, well completion operations, well delivery operations, well diagnostics, and/or drilling operations in order to modify the state of a well or well geometry. Some of these operations may involve issuing commands (e.g., command (155)), e.g., by transmitting commands to various network devices (e.g., control system (144)) in a drilling system as well as various user devices at the well site. In one or more embodiments, the recommender system (160) includes one or more of the elements discussed below.

While FIG. 1 shows a drilling system, embodiments of the disclosure are applicable to other configurations as well, e.g., a production system.

Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated embodiments, but to be accorded the widest scope consistent with the described principles and features.

In some embodiments, techniques of the present disclosure can provide a representation learning to massive petroleum engineering system (ReLMaPS), organized as knowledge graphs or networks. For example, a knowledge discovery engine may be built around an ontological framework with an evolving PE vocabulary that enables automated unified semantic querying. The techniques may include techniques that combine, for example, techniques used in deep representation learning (DRL), online purchasing and network based discovery, disease pathways discovery, and drug engineering for therapeutic applications. The techniques may also provide, for example: 1) implementation of knowledge graphs and networks of large-scale (or big data) PE systems data as a unified knowledge engine for DRL; 2) an integration of DRL tools, such as graph convolutional neural networks (GCNNs) in PE knowledge graphs, as enablers for implementations of large-scale recommendation (or advisory) systems; and 3) an integration of case- and objective-specific smart agents focusing on providing recommendation/advice on decision actions related to production optimization, rapid data-driven model calibration, field development planning and management, risk mitigation, reservoir monitoring, and surveillance. For example, optimization can refer to setting or achieving production values that indicate or result in a production above a predefined threshold or to setting or achieving production values that minimize the difference or misfit between the numerically simulated model and observed or measured data.

In general terms, an ontological framework (OF) may connect and define relationships between data that is distributed, stored, and scattered through disparate sources using high-level mappings. The relationships may facilitate automatic translation of user-defined queries into data-level queries that may be executed by the underlying data management system. For example, automated translation from user-defined queries to data-level queries may be implemented in the realm of using reservoir simulation models to generate and rank production forecasts. An example of a user-defined semantic query can be “Identify all simulations models in which the estimate of ultimate recovery is greater than XXX % (in relative terms, such as produced reserves over original oil in place) or greater than YYY millions of barrels of oil (in absolute, cumulative terms)”. The translation may map such a user-defined semantic query to data-type specific metadata that will capture and rank (by ultimate recovery yet above the threshold) the models with specific information (for example, number of producer and injector wells, number and types of completions, number and subsea-depth of zones from which the wells produce, type of well stimulation used, and type of recovery strategy used). Table 1 represents the complexity of data sources that may be used as inputs to massive PE systems. The data sources may be characterized by volume, velocity, variety, veracity, virtual (data), variability, and value. Additional data sources may exist, without departing from the disclosure.

TABLE 1
Data Sources for Large PE Systems

| Categories | Information Asset Name |
|---|---|
| Petrophysical Data | Well logging |
| | Formation testing (well logging) |
| | Flowmeter survey |
| | Special core analysis (SCAL) |
| | Core |
| Well Testing | Raw Phase I, II survey (build-up and fall-off |
| | Pressure transient analysis (PTA) |
| | DST |
| Reservoir Information | Completion events |
| | Well status |
| | Pay summary |
| | Fluid contacts |
| | Field reservoir data |
| | Inflow performance relationship (IPR) block |
| | Perforating |
| | Ministry of Petroleum Affairs (MINPET) |
| | report |
| | Metrics |
| | Tubing details |
| | Casing details |
| | Plug installations |
| Well Surveillance | Annuli survey |
| | Pressure survey |
| | Temperature survey |
| | Well Rate |
| | Well scale monitoring |
| | Wireline services |
| | PE real-time data |
| Product Engineering Field | Well stimulation |
| Jobs | Fish |
| | Inhibitor jobs |
| Production Injection Data | Production injection volumes |
| | Well operating data |
| | Avails |
| | Targets |
| Lab Samples and Analyses | Water sample analysis |
| | Gas sample analysis |
| | Crude sample analysis |
| | Pressure/volume/temperature (PVT) Analysi |
| Equipment and Facilities | Wellheads and chokes |
| | Surface facilities |
| | Electrical submersible pump (ESP) |
| | Installations and performance |
| | Geographical information system (GIS) |
| | Well tie-in |
| Models | Wells and networks models |
| | Simulation models |
| | Simulation workflows |
| | Geo and fracture models |
| | PVTSim |
| | ESP (Electric Submersible Pump) models |
| | Material balance models |
| Well Planning and | Well activity scheduling and |
| Approvals | tracking |
| | Integrated business planning |
| | Well planning and approvals |
| Well Master Inventory | Well master inventory |
| Directional Survey | Deviation survey |
| Locked Potential | Locked potential |
| Reports | Maps |
| | Isobaric maps structure maps |
| | Fluid contact maps bubble maps |
| | Pore-volume |
| | Net thickness map porosity map |
| | Permeability map |
| | Reserves sheet |
| | Daily completion/stimulation reports |
| | Drilling requirements |
| | Land use |
| | Well activities/events |
| | Basic reservoir data sheets |
| | MINPET report |
| | Crude slate |
| | Reservoir performance report |
| | Separator and deliverability test |
| | Other reports |

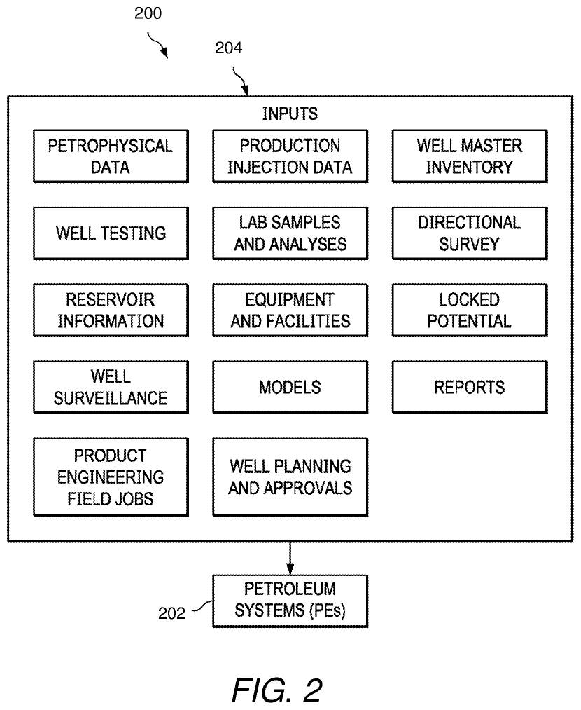

FIG. 2 is a block diagram showing an example of a system (200) using categories of inputs (204) to update petroleum systems (PEs) (202), according to some implementations of the present disclosure. For example, the inputs (204) may include the categories of inputs (for example, databases, documents and records of information assets) identified in Table 1.

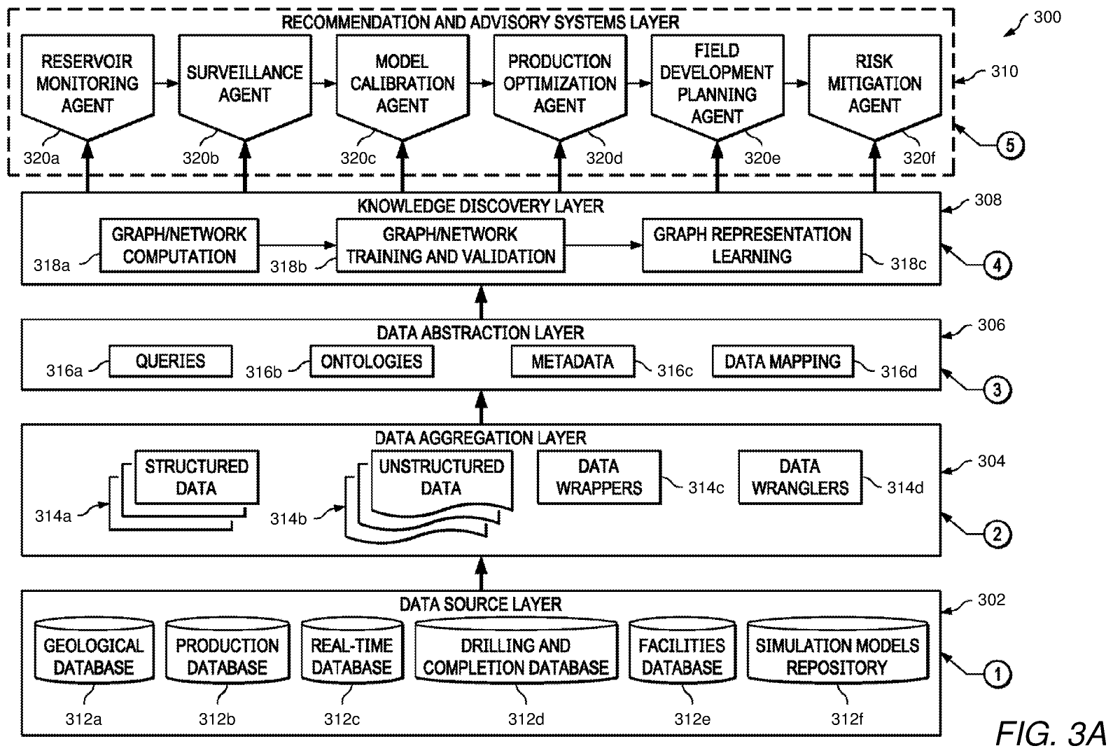

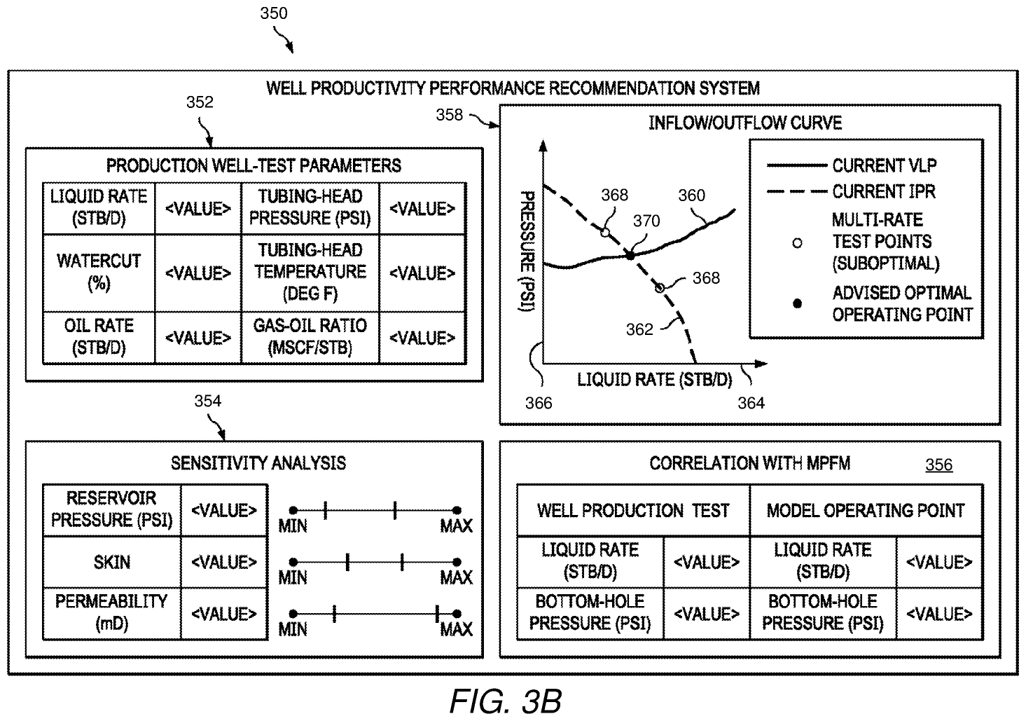

FIG. 3A is a block diagram showing an example of layers (302-310) within a representation learning to massive petroleum engineering system (ReLMaPS) (300), according to some implementations of the present disclosure. The layers (302-310) may be used to implement Steps 1-5, respectively, of a method provided by the ReLMaPS (300) (or system (200)).

In a data source layer (302) (Step 1), source data is accessed. The source data may include data sources (312a-312f), including the data associated with the input categories outlined in Table 1. Data sources may be interconnected and stored in databases and repositories, combining geological data, production data, real-time data, drilling and completion data, facilities data, and simulation models repositories. For example, the term real-time data may correspond to data that is available or provided within a specified period of time, such as within one minute, within one second, or within milliseconds.

In a data aggregation layer (304) (Step 2), the source data may be aggregated using techniques such as data wrangling, data shaping, and data mastering. Aggregation may be performed on structured data (314a), unstructured data (314b), data wrappers (314c), data wranglers (314d), and streaming data, for example. Some data types may be abstracted in the form of OFs. In some implementations, the OFs for the domain of PE systems data may be modeled as classified in three main categories. A first category of Things may represent electro-mechanical components such as wells, rigs, facilities, sensors, and metering systems.

A second category of Events may represent actions (manual or automated) which may be executed by components of the Things category. For example, actions may be used to combine measurements, validation, and conditioning of specific dynamic responses, such as pressure and fluid rates. Things and Events categories may be interconnected and related through principles of association.

A third category of Methods may represent technology (for example, algorithms, workflows, and processes) which are used to numerically or holistically quantify the components of the Events category. The Events and Methods categories may be causally interconnected through the principles of targeting.

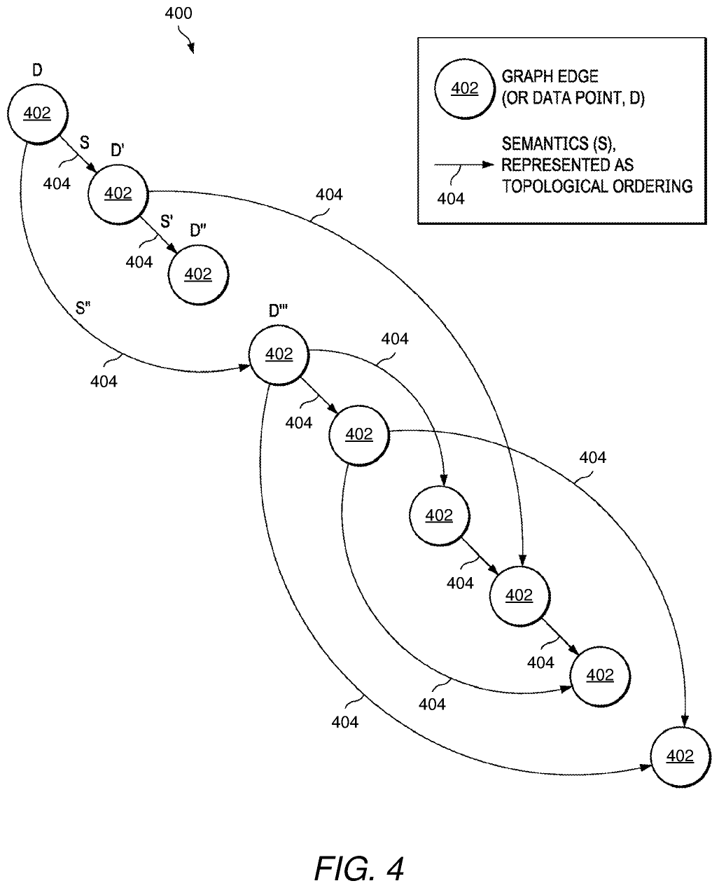

PE ontologies may be organized, for example, as directed acyclic graphs (DAGs) that include connected root nodes, internal nodes, and leaf nodes. Distances between nodes (for example, meaning relatedness between nodes) may be calculated based on similarity, search, or inference. Schematically, the topological ordering of DAGs may be represented (as shown in FIG. 4) as circles connected by graph edges (representing data) and arrows depicting semantic relations between the edges.

Referring again to FIG. 3A, in a data abstraction layer (306) (Step 3), components of ontological frameworks (for example, including Things, Events, and Methods) may be built. The ontological frameworks may represent building blocks of the PE system including, for example, queries (316a), ontologies (316b), metadata (316c), and data mapping (316d).

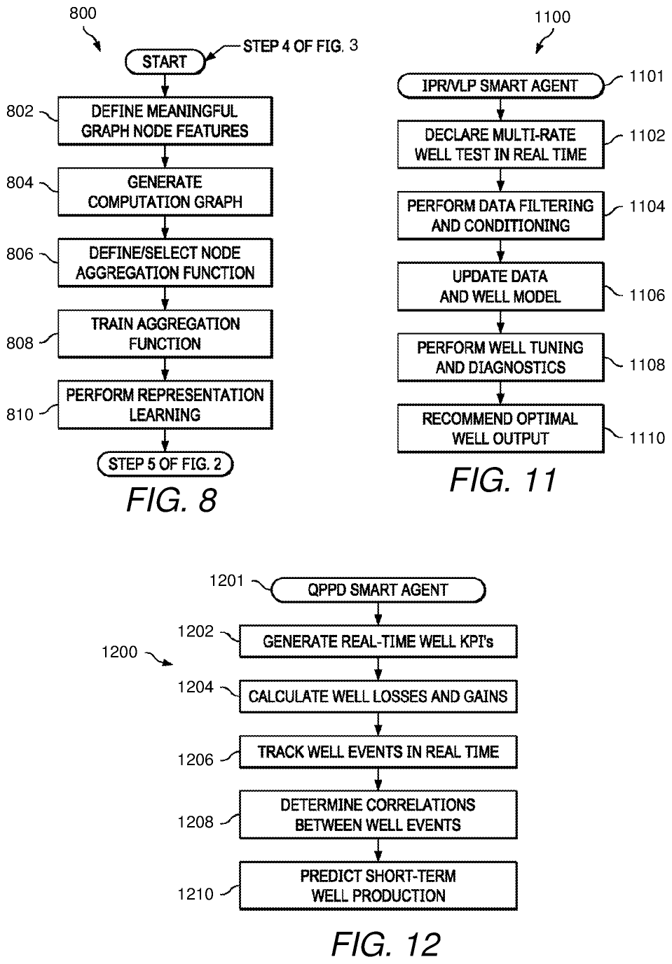

In a knowledge discovery layer 308 (Step 4), a knowledge discovery engine may be built. The knowledge discovery layer (308) may use processes that include, for example, graph/network computation (318a), graph/network training and validation (318b), and graph representation learning (318c). The knowledge discovery engine may be specifically designed for massive PE systems data using various algorithms. A detailed implementation example of the main sub-steps of Step 4 of FIG. 3A is presented in FIG. 8.

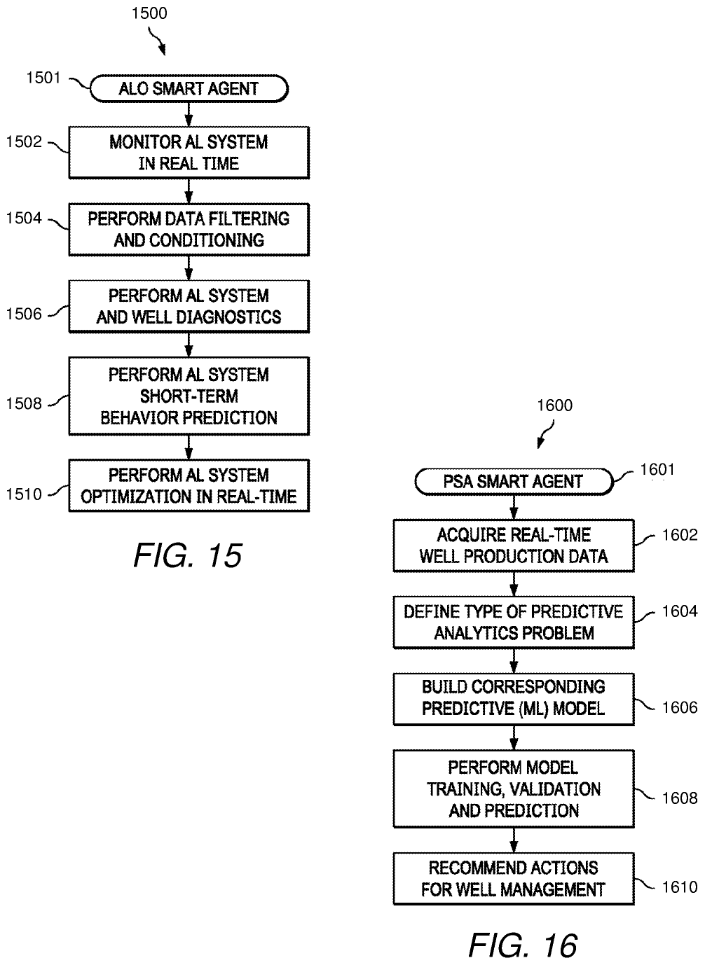

A recommendation and advisory systems layer (310) (Step 5) may be built that is used to make recommendations and advisories. For example, the recommendation and advisory systems layer (310) may be built using smart agents that correspond to different stages of PE business cycle. The recommendation and advisory systems layer (310) may use agents including, for example, a reservoir monitoring agent (320a), a surveillance agent (320b), a model calibration agent (320c), a production optimization agent (320d), a field development planning agent (320e), and a risk mitigation agent (320f). Building the recommendation and advisory systems layer may include combining smart agents, corresponding to different stages of PE business cycle. In some implementations, the agents (320a-320f) may be implemented as described with reference to FIGS. 11-15.

The reservoir monitoring agent (320a) may perform smart wells ICV/ICD management, oil recovery management (smart IOR/EOR), and well IPR/VLP, for example. The surveillance agent (320b) may perform, for example, calculation of key process indicators (KPIs), production losses and downtime, quick production performance diagnostics, and short-term predictions. The model calibration agent (320c) may perform, for example, uncertainty quantification (UQ), assisted history matching (AHM), and forecasting.

The production optimization agent (320d) may perform, for example, closed-loop RM, production analytics, and injection allocation optimization. The field development planning agent (320e) may perform, for example, optimal well placement, artificial lift optimization (for example, electrical submersible pumps (ESPs) and gas lifts (GLs)), and ultimate recovery (UR) maximization and optimal sweep. The risk mitigation agent (320f) may perform, for example, probabilistic scenario analysis, portfolio analysis, and minimize risk (for example, to maximize return).

FIG. 3B is a screenshot showing an example of a user interface (350) for a well productivity performance recommendation system, according to some implementations of the present disclosure. In some implementations, recommendations/advisories may be presented to the user using the user interface (350), and the information may be used by the user, for example, to make changes in production. The information may be generated by sub-systems of the well productivity performance recommendation system, for example. A representation learning system may learn information, for example, on wellbore damage (skin), equipment wear, multiphase-flow correlations (for example, from multiphase flow meter or MPFM) from the PE network/database containing many well modeling iterations (for example, using steady-state nodal analysis) performed across many assets. A recommendation/advisory system (for example, including smart agents) may execute sensitivity analysis, evaluate well productivity performance, recommend choke and/or artificial lift settings (for example, vertical lift performance (VLP)) to maintain optimal operating point (for example, inflow performance relationship (IPR)), and update well models.

A production well-test parameters information area (352) may be used to display current values, for example, of liquid rate, watercut, oil rate, tubing head pressure, tubing head temperature, and gas-oil ratio. A sensitivity analysis information area (354) may be used to display minimum and maximum range values for reservoir pressure, skin, and permeability. A correlation with MPFM information area (356) may be used to display well production test data (for example, liquid rate and bottom-hole pressure) and model operating point data (for example, liquid rate and bottom-hole pressure). An inflow/outflow curve (358) may be used to display plots including a current VLP plot (360) and a current IPR plot (362) (relative to a liquid rate axis (364) and a pressure axis (366)). The plots may include multi-rate test points 368 and an advised optimal operating point (370).

FIG. 4 is a graph showing an example of a topological ordering (400) of directed acyclic graphs (DAGs), according to some implementations of the present disclosure. For example, in the topological ordering (400), circles (402) are used to depict graph nodes (or data) and arrows (404) are used to depict semantic relations between the nodes. The edges depicted in FIG. 4 include edges occurring earlier in the ordering (upper left) to later in the ordering (lower right). A DAG may be said to be acyclic if the DAG has an embedded topological ordering.

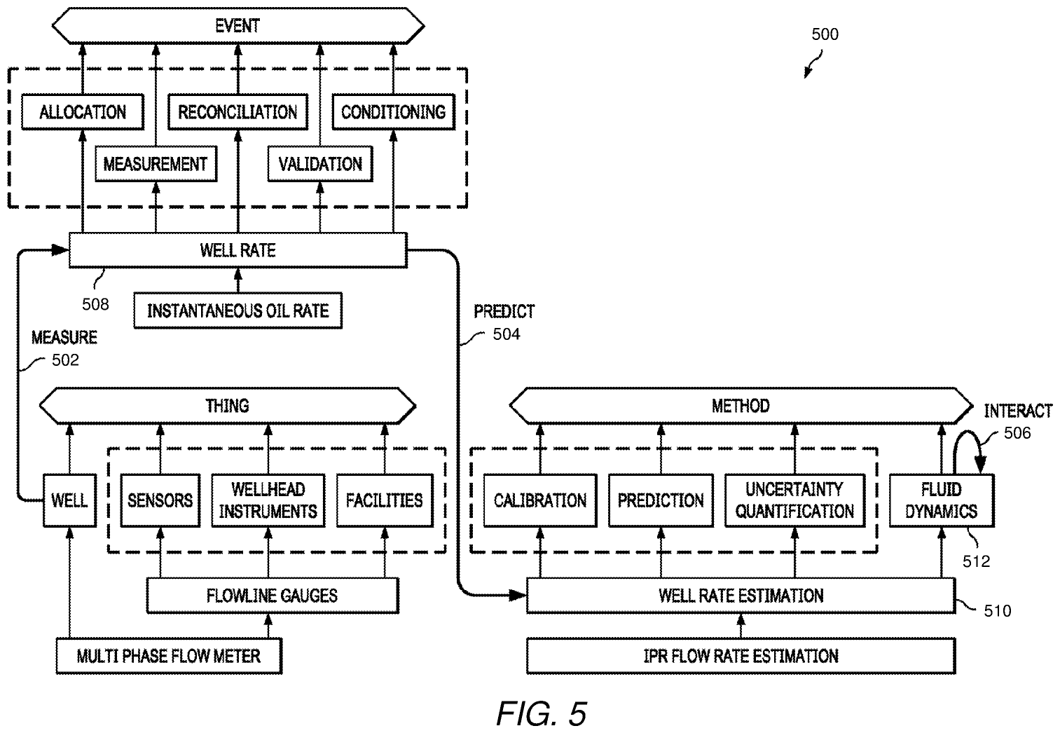

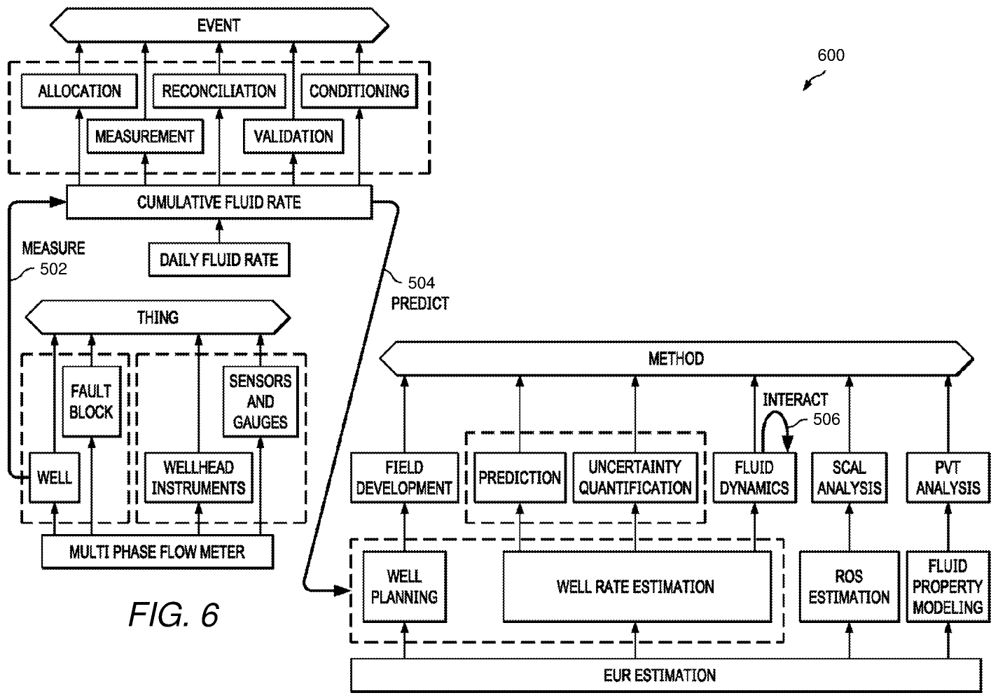

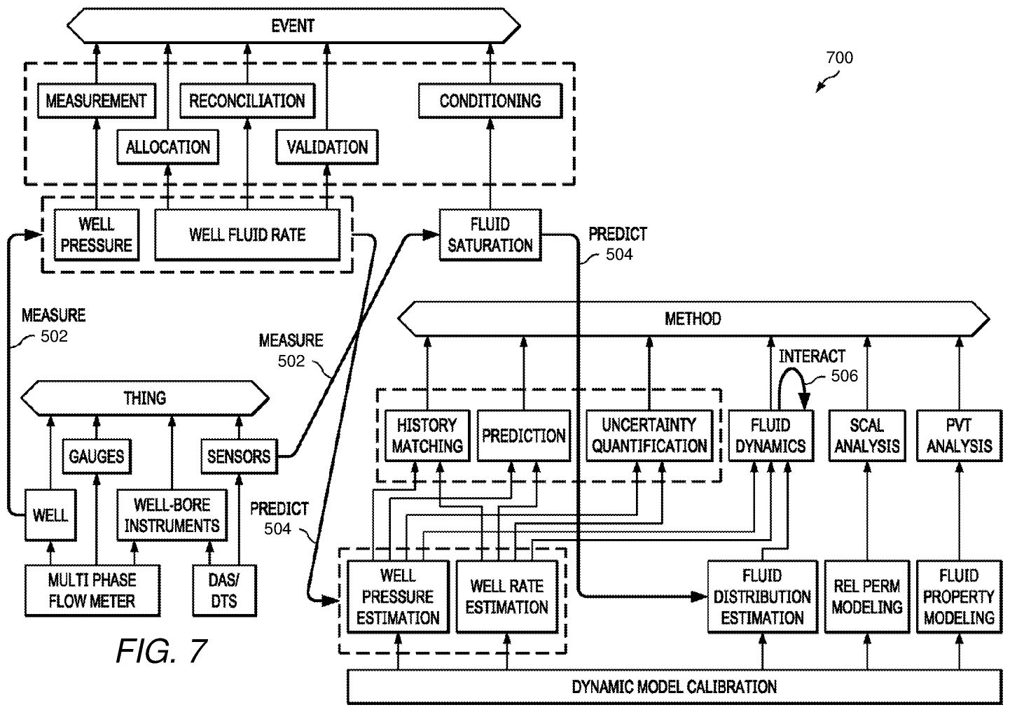

The present disclosure presents schematic examples of three different OFs pertaining to PE systems data, represented in the form of DAGs (with increasing graph feature complexity). For example, an OF/DAG corresponding to the process of well flow rate estimation is presented in FIG. 5, an OF/DAG corresponding to the process of estimation of ultimate recovery (EUR) is presented in FIG. 6, and an OF/DAG corresponding to the process of dynamic calibration of reservoir simulation model is presented in FIG. 7.

FIG. 5 is a network diagram of an example of a network (500) for the ontological framework (OF)/DAG corresponding to the process of well flow rate estimation, according to some implementations of the present disclosure. Semantic relationships between DAGs data points, labeled as Measure (502), Predict (504), and Interact (506), are represented in FIGS. 4-6 using thick arrows. As shown by the thick arrows, well rate (508) may be measured by a multiphase flow meter (MPFM) (associated with the well), and well rate estimation (510) may be a method for predicting the well rate. Fluid dynamics (512) calculations may be performed with the reservoir simulator, which may represent a non-linear estimator of physical interaction phenomena between model grid properties and fluid properties.

FIG. 6 is a network diagram of an example of a network (600) for the OF/DAG corresponding to the process of estimation of ultimate recovery (EUR), according to some implementations of the present disclosure. The network (600) is similar to the network (500) of FIG. 5, including the same data points labeled as Measure (502), Predict (504), and Interact (506). However, the networks (500) and (600) include different sets of nodes associated with different types of processing (for example, well flow rate estimation versus EUR).

FIG. 7 is a network diagram of an example of a network (700) for the OF/DAG corresponding to the process of dynamic calibration of a reservoir simulation model, according to some implementations of the present disclosure. The network (700) is similar to the network (500) of FIG. 5 and the network (600) of FIG. 6. The network (700) includes multiple data points labeled as Measure (502), Predict (504), and Interact (506). However, the network (700) includes different sets of nodes associated with different types of processing (for example, the process of dynamic calibration of the reservoir simulation model instead of processing associated with well flow rate estimation versus EUR of networks (500) and (600), respectively).

Tables 2 and 3 provide examples for the classification of graph features for graph nodes and graphs edges, respectively, for use in large-scale PE systems data. In some implementations, identifying components of ontological frameworks (for example, including Things, Events, and Methods) may be done using step 3 of FIG. 3A. The components may be used as building blocks of computational graph nodes and edges.

TABLE 2
Example classification of PE systems graph Nodes

| Graph Features | Graph Node | Node Label |
|---|---|---|
| Things | Well | T1 |
| | Gauges | T2 |
| | Well-bore Instruments | T3 |
| | Sensors | T4 |
| Events | Well Pressure | El |
| | Well Fluid Rate | E2 |
| | Fluid Saturation | E3 |
| Methods | Well Pressure Estimation | M1 |
| | Well Rate Estimation | M2 |
| | Fluid Distribution Estimation | M3 |
| | Fluid Properties modeling | M4 |
| | Relative Permeability modeling | M5 |

TABLE 3
Example classification of PE systems graph Edges

| Graph Features | Graph Edge | Aggregation Label |
|---|---|---|
| Events | Measurement | EAgg1 |
| | Allocation | EAgg2 |
| | Reconciliation | EAgg3 |
| | Validation | EAgg4 |
| | Conditioning | EAgg5 |
| Methods | History Matching | MAgg1 |
| | Prediction | MAgg2 |
| | Uncertainty Quantification | MAgg3 |
| | Fluid Dynamics | MAgg4 |
| | PVT Analysis | MAgg5 |
| | SCAL Analysis | MAgg6 |

FIG. 8 is a flow diagram of an example of a process (800) for building a knowledge discovery engine, according to some implementations of the present disclosure. For example, the process (800) may be used to implement step 4 of FIG. 3A. Graph Neural Networks (GNNs) provide a framework for machine and deep learning (ML/DL) on graphs. The GNNs can automatically learn the mapping to encode complex graph structures such as graph nodes or entire (sub)graphs into representative low-dimensional embeddings. The learned embeddings can be used as feature inputs for ML/DL tasks.

In Step 802, meaningful graph features, as nodes and edges, are defined. Tables 2 and 3 provide examples of classifications of graph features used for large-scale PE systems data. Step 802 may be performed, for example, after identifying components of ontological frameworks built in step 3 of FIG. 3A (for example, including Things, Events, and Methods) as building blocks of computational graph nodes and edges.

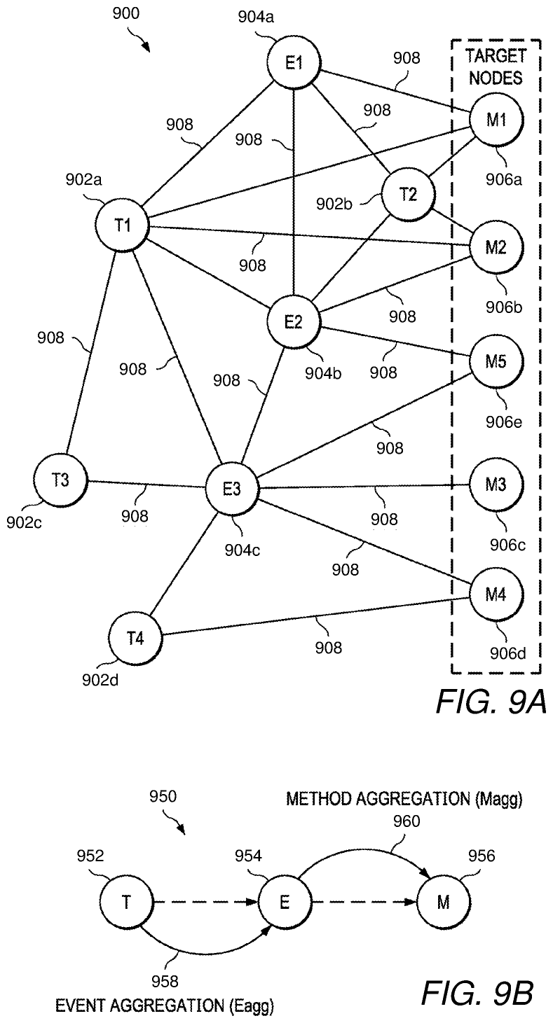

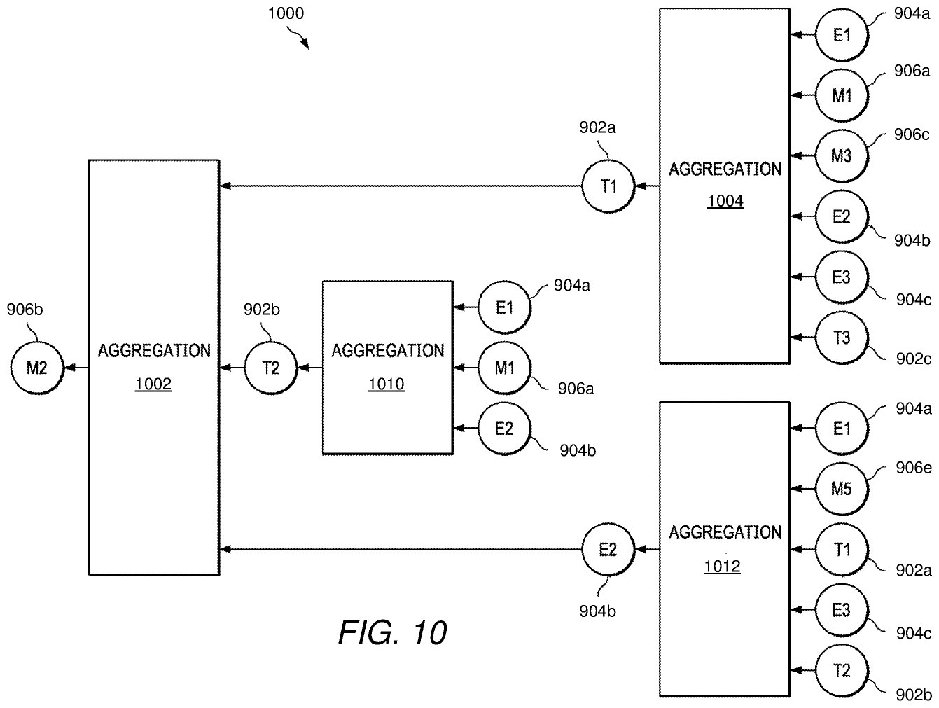

In Step 804, the computation graph corresponding to specific task of PE systems data representation learning is generated. For example, components of ontological frameworks built in step 3 of FIG. 3A (for example, including Things, Events, and Methods) may be associated with building blocks of computational graph nodes and edges. In FIG. 9A, an example is given of computation graph attributed to dynamic simulation model calibration.

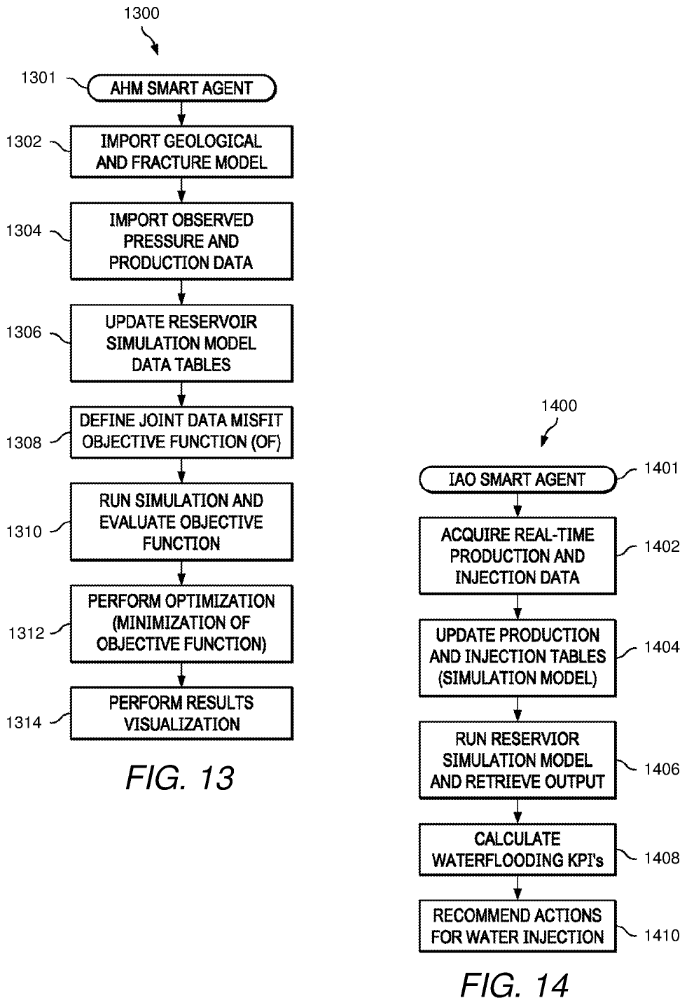

In Step 806, a graph node aggregation function is identified and deployed as illustrated in FIG. 10. For example, graph recursive neural networks (GRNN) may be identified as aggregation function for text data (for example, using PE systems unstructured data). Graph convolutional neural networks (GCNN) and generative adversary networks (GAN) may be identified as aggregation function for grid-based data (for example, using reservoir simulation grid properties). Time-varying graphical lasso (TGL) techniques may be identified for aggregation of time series (for example, using pressure and fluid rate response profiles).

In Step 808 the aggregation function is trained. For example, the aggregation function may be trained using historical PE data.

In Step 810, deep representation learning (DRL) is performed with trained aggregation function. After the completion of step 4 of FIG. 3A, the process may continue at the recommendation and advisory systems layer (Step 5 of FIG. 3A).

FIG. 9A is a network diagram showing an example of a computation graph (900) corresponding to a specific task of PE systems data representation learning, according to some implementations of the present disclosure. For example, the computation graph (900) provides an example of a computation graph attributed to dynamic simulation model calibration. The computation graph (900) includes Thing nodes (902a-902d), Event nodes (904a-904c), and Method nodes (906a-906e). Thing (T) nodes (902a-902d) and Event (E) nodes (904a-904c) represent nodes of a knowledge graph used, for example, in dynamic simulation model calibration. Method (M) nodes (906a-906e) represent target nodes combined into graph representation used, for example, in dynamic simulation model calibration. Thing nodes (902a-902d), Event nodes (904a-904c), and Method nodes (906a-906e) may be interconnected by graph edges (908), where the edges (908) represent an aggregation function.

FIG. 9B is a network diagram showing an example of a network (950) showing aggregations, according to some implementations of the present disclosure. The network (950) shows an event aggregation (Eagg) (958) between a Thing node (952) and an Event node (954). The network (950) also shows a method aggregation (Magg) (960) between the Event node (954) and a Method node (956). The Eagg (958) and the Magg (960) provide examples of aggregations associated with the Things, Events, and Methods of the network (900). Tables 2 and 3 include notations that correspond to FIGS. 9A and 9B.

FIG. 10 is an example of a computation graph (1000) corresponding to an example of graph representation learning process for well rate estimation, according to some implementations of the present disclosure. For example, the computation graph (1000) may correspond to node M2 (906b) in FIG. 9A. At the highest level, information from nodes T1 (902a) and T2 (902b) is aggregated and associated with method node M2, which corresponds to well rate estimation. Specifically, aggregation function (1002) for node M2 (906b), corresponding to well rate estimation, for example, is performed using three input nodes. The three input nodes include Thing nodes T1 (902a) and T2 (902b) (corresponding to a well and gauges in the ontological framework of FIG. 6) and Event node E2 (904b).

In general, information at node labels E1, M1, M3, E2, E3 and T3 (see Table 2) is aggregated by aggregation function (1004) and associated with the well node represented by Thing node T1 (902a). Examples of aggregation functions are defined in the description of FIG. 8, and events and methods represented in the aggregation are listed in Table 3.

In general, information at node labels E1, M1, and E2 (see Table 2) is aggregated in data aggregation (1010) and associated with a gauges node represented by T2. Examples of aggregation functions are defined in the description of FIG. 8, and events and methods represented in the aggregation are listed in Table 3.

In general, information at node labels E1, M5, T1, E3 and T2 (see Table 2) is aggregated in data aggregation (1012) and associated with a well node represented by Event node E2 (904b). Examples of aggregation functions are defined in the description of FIG. 8, and events and methods represented in the aggregation are listed in Table 3.

Aggregation may be performed by learning network/graph representations. Example is given for the Well Rate Estimation (M2), by learning PE system network/graph representations, to predict a well Productivity Index (PI) of a newly-drilled well, aggregated by aggregation function (1002). Table 2 provides examples of PE systems graph nodes labeling and notations. Table 3 provides examples of PE systems graph edges labeling and notations.

As indicated in FIG. 10, the input of aggregation function 1002 connects three graph edges, feeding from: 1) Thing node T2 (902b), for example, represented by a permanent downhole gauge (PDG); 2) Thing node T1 (902a), for example, represented by a well; and 3) Event node E2 (904b), for example, represented by a well fluid rate. Since the output of aggregation function 1002 is the method for estimating well rates (for example, including oil, water, and gas), the aggregation function itself may be represented by the Magg2 (prediction), which predicts the well productivity index (PI). One example representation of the Magg2 function is PI=Qf/(Pres—PfBHP), where Q corresponds to a fluid rate (for example, oil, water, and gas), Pres corresponds to a reservoir pressure, and PfBHP corresponds to a well flowing bottom-hole pressure (fBHP). Aggregation of each node T1 (902a), T2 (902b), and E2 (904b) is respectively described in detail.

Aggregation of node T1 (902a) with function (1004) starts with reading of input data from nodes represented by the following events, methods, and things. Event E1 corresponds to a well flowing bottom-hole pressure (fBHP). E1 may be measured, for example, by a permanent downhole pressure gauge. Event E2 corresponds to a well fluid rate Q. E2 may be measured, for example, using a multi-phase flow meter (MPFM). Method M1 corresponds, for example, to a well overbalanced pressure estimation. Method M3 may correspond to a fluid distribution estimation, with representation, for example, from streamline-generated drainage regions. Event E3, corresponding to fluid saturation, may be calculated by a finite-difference reservoir simulator as a function of time throughout field production history. Thing T3, corresponding to a well-bore instrument, may be a distributed acoustic sensor (DAS) or a distributed temperature sensor (DTS).

For individual nodes previously described, feeding the aggregation function (1004) may include receiving information or data from neighboring nodes in the network that are interconnected with adjacent edges. Since aggregation function (1004) is an input graph node of Things (for example, T1, representing the liquid-producing well), the aggregation function (1004) may correspond to Allocation, Eagg2. For example, Eagg2 correctly allocates the fluids gathered at well-gathering stations (for example, gas-oil separation plants (GOSP)) onto individual wells connected using surface production network systems. One such example of an aggregation function, corresponding to well-production Allocation, is a data reconciliation method. The data reconciliation method may be a statistical data processing method that calculate a final well-production value, for example, when the two or more different sources and measurement are available.

Aggregation of node T2 (902b) with function (1010) starts with reading of input data from the following nodes. Event E1 corresponds to a well flowing bottom-hole pressure (fBHP), measured by, for example, a permanent downhole pressure gauge. Event E2 corresponds to a well fluid rate Q, measured by, for example, a multi-phase flow meter (MPFM). Method M1, for example, corresponds to well overbalanced pressure estimation. However, since aggregation function (1010) is an input to a graph node of Things (T2), representing well measurement gauges, the aggregation function (1010) corresponds to Measurement, Eagg 1. An example of aggregation function Eagg 1 is the numerical model for the calculation of inflow performance relationship (IPR) and well vertical lift performance (VLP). An example of representation learned from the IPR/VLP curve(s) is the optimal operating point corresponding to the cross-point between IPR curve and tubing performance curve.

It is noted that the three nodes E1, E2, and M1 feeding the aggregation function (1010) also represent a subset of nodes feeding the aggregation function (1004). This illustrates that individual representation learning or aggregation functions connected in a complex network or graph may share or complement nodal information from neighboring nodes using network adjacency.

Aggregation of node E2 (904b) with function (1012) starts with reading of input data from nodes represented by the following nodes. Event E1 corresponds to well flowing bottom-hole pressure (fBHP), measured by, for example, a permanent downhole pressure gauge. Event E3 corresponds to fluid saturation, calculated, for example, by a finite-difference reservoir simulator as a function of time throughout field production history. Method M5 corresponds to relative permeability modeling, used to learn representations of fractional-phase fluid movement (for example, water, oil, and gas) in the presence of other fluids. Thing T1 represents, for example, the liquid-producing well. Thing T2 represents, for example, well measurement gauges, such as a permanent downhole gauge (PDG).

The aggregation function (1012) is an input to a graph node of Events (E2), representing a time-dependent well fluid rate profile. As such, the aggregation function (1012) may correspond, for example, to the following single function or a combination of the following functions: a data validation function, Eagg4; a data conditioning and imputation function, Eagg5; and a special core analysis (SCAL), Maggio. The data validation, Eagg4, may be, for example, a QA/QC cleansing and filtering of raw time-dependent well fluid rate measurements. The measurements may be acquired from well measurement gauges, as represented with network/graph edge connectivity to nodes T1 and T2. Examples of data validation functions include, for example, rate-of-change recognition, spike detection, value-hold and value-clip detection, out-of-range detection, and data freeze detection. The data conditioning and imputation, Eagg5, may use raw time-dependent well fluid rate measurements. The measurements may be acquired from well measurement gauges, as represented with network/graph edge connectivity to nodes T1 and T2. Examples of data validation functions include, for example, simple averaging (or summarizing), extrapolation following trends and tendencies, data replacement by data-driven analytics (such as maximum-likelihood estimation), and physics-based calculations (such as virtual flow metering). The special core analysis (SCAL), Maggio, may use interpretation of lab core experiments (for example, centrifuge, mercury-injection capillary pressure (MICP)) to derive relative permeability models as representations of fractional-phase fluid movement (water, oil and gas) in the presence of other fluids.

The event nodes E1 and E3 feeding the aggregation function (1012) also represent a subset of nodes feeding the aggregation function (1004). Moreover, the two Things nodes T1 and T2 feeding the aggregation function (1012) also represent the aggregated node of the aggregation functions (1004) and (1010). This illustrates that individual representation learning or aggregation functions connected in a complex network or graph frequently share or complement nodal information from neighboring nodes using network adjacency and topological ordering of directed acyclic graphs (DAG), as illustrated in FIG. 3.

FIG. 11 is a flow diagram of an example of a smart agent process (1100) for well inflow performance relationship/vertical lift performance (IPR/VLP) performance, according to some implementations of the present disclosure. The smart agent process (1100) may be implemented with a reservoir monitoring agent for calculating well IPR/VLP performance (for example, IPR/VLP smart agent (1101)).

In Step 1102, multi-rate well test data is declared in real time. In Step 1104, data filtering and conditioning is performed with a series of algorithms that automatically clean, eliminate spikes, detect frozen data, and estimate the average and standard deviation of the data. Data conditioning functions may include, for example, rate of change, range checks, freeze checks, mean and standard deviation, filtering, and stability check. In Step 1106, data and the well model are updated, for example, using nodal analysis. In Step 1108, well tuning and diagnostics are performed, for example, using nodal analysis. In Step 1110, an optimal well output is recommended.

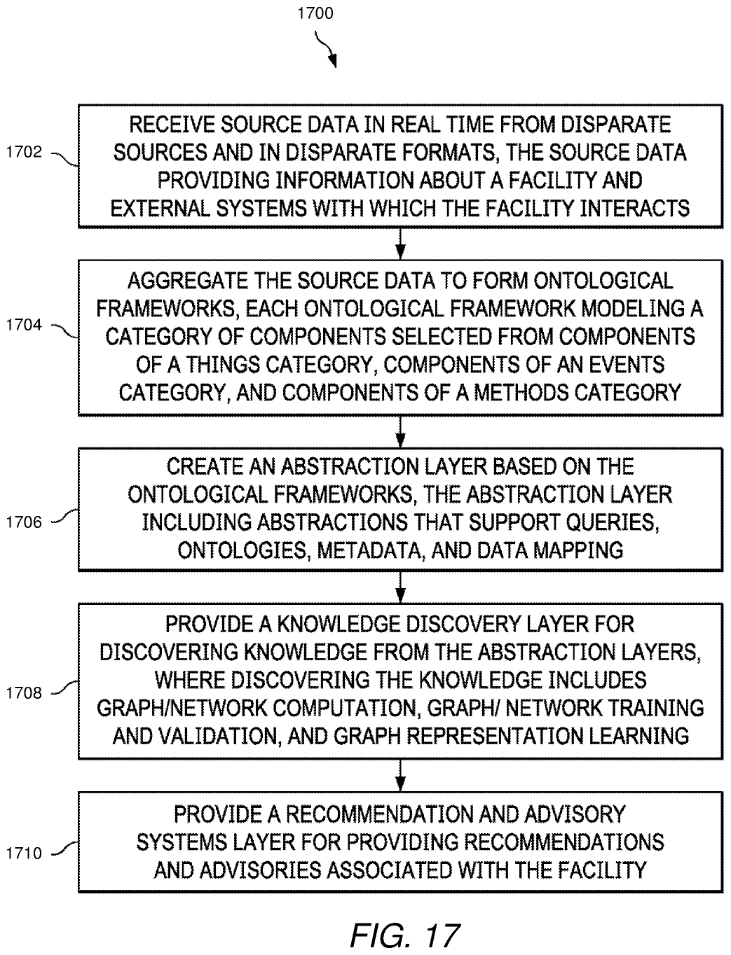

FIG. 12 is a flow diagram of an example of a smart agent process (1200) for quick production performance diagnostics (QPPD), according to some implementations of the present disclosure. For example, the smart agent process (1200) may be implemented using a surveillance agent for QPPD (for example, QPPD smart agent (1201)).

In Step 1202, real-time well KPIs are generated. For example, critical well thresholds and constraints are generated and compared with current well conditions (for example, minimum and maximum pressure targets, and liquid and gas production constraints). In Step 1204, well losses and gains are calculated. Production deviations are calculated instantaneously (daily to account for well-level losses) and cumulatively (total losses and gain per day, month, and year). For example, the virtual metering system based on nodal modeling may be used to estimate well liquid production and well watercut. In Step 1206, well events are tracked in real-time using connectivity to sensor network systems (for example, supervisory control and data acquisition (SCADA) or Internet of Things (IoT)). Well events lists may contain, for example, well workovers, shut-ins, measurements and other manipulations. In Step 1208, correlations between well events are determined. For example, spatial correlations between water injection wells and producing wells may be estimated by pattern analysis and by using streamline modeling. Further, clustering techniques may be used to group wells based on dynamic response (dis)similarity. In Step 1210, short-term well production may be predicted, for example, the short-term well production response may be generated by using predictive modeling and machine learning (ML).

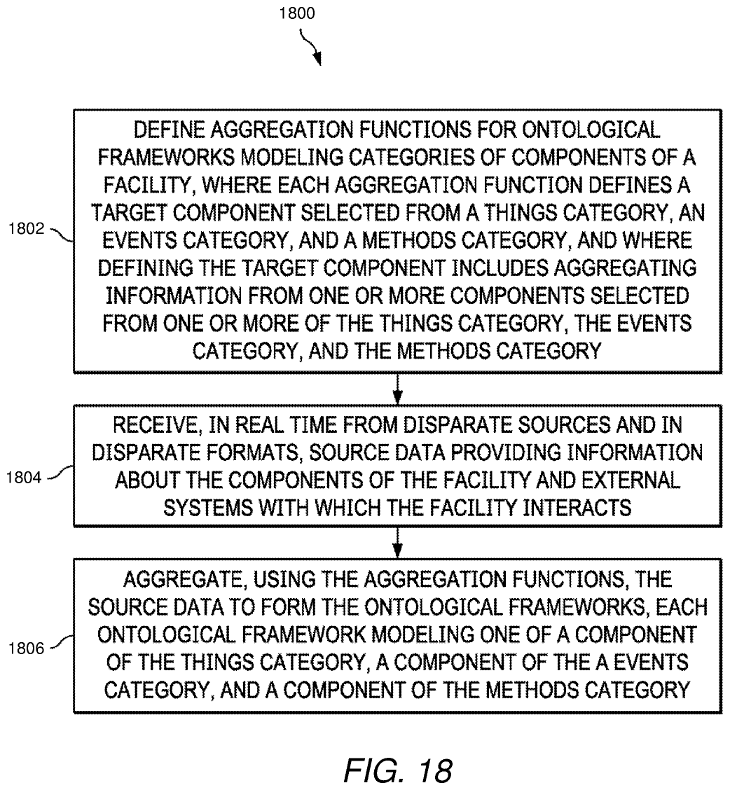

FIG. 13 is a flow diagram of an example of a smart agent process (1300) for computer-assisted history matching (AHM), according to some implementations of the present disclosure. The smart agent process (1300) may be implemented, for example, using an AHM smart agent (1301), which may perform the following steps.

In Step 1302, the geological and fracture models (for example, three-dimensional (3D) structural grids with associated subsurface properties) are imported. In Step 1304, the observed well pressure and production data are imported. In Step 1306, the reservoir simulation model data tables are updated with imported data. In Step 1308, the agent builds a joint data misfit objective function (OF), which may combine prior model terms (corresponding to the misfit reservoir subsurface properties of geological and fracture models) and likelihood terms (corresponding to the misfit between the observed and calculated dynamic pressure and production data). In Step 1310, the misfit OF is validated using a non-linear estimator, namely the reservoir simulator, for dynamic response in terms of well pressure and production data. In Steps 1312, the process of optimization is performed with the objective to minimize the misfit OF and obtain an acceptable history match between the observed and simulated data. The optimization process may be deterministic or stochastic and may be performed on a single simulation model realization or under uncertainty, using an ensemble of statistically diverse simulation model realizations. In Step 1314, the agent visualizes the results of AHM optimization process as time series, aggregated reservoir grid properties, and quality maps.

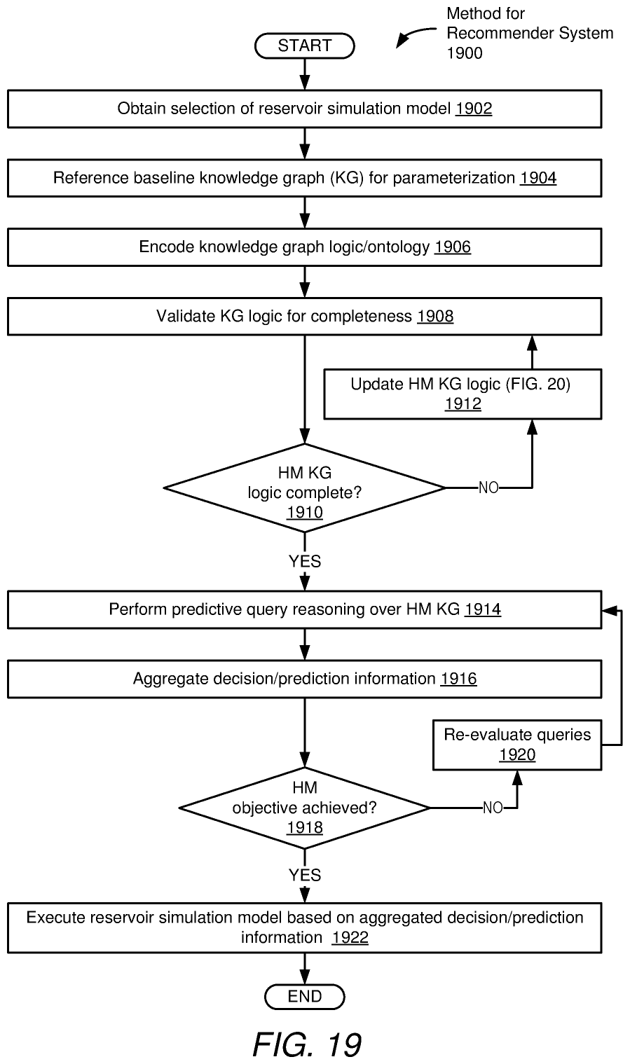

FIG. 14 is a flow diagram of an example of a smart agent process (1400) for injection allocation optimization (IAO), according to some implementations of the present disclosure. The smart agent process (1400) may be implemented, for example, using a production optimization agent for IAO (for example, IAO smart agent (1401), which may perform the following steps).

In Step 1402, data associated with real-time well injection and production is acquired, for example, using connectivity to sensor network systems (for example, SCADA or IoT). In Step 1404, the acquired data is used to update the production and injection tables of the operational reservoir simulation model. In Step 1406, the reservoir simulation model is executed with updated injection and production data, and the simulation run output is retrieved. Different scenarios of waterflooding management may include, for example, using voidage replacement ratio (VRR) constraints or reservoir pressure maintenance control. In Step 1408, waterflooding KPIs are calculated, including, for example, VRR time series and cumulative behavior, reservoir nominal pressure behavior, fluid displacement, and volumetric efficiency. In Step 1410, the proactive recommendation is generated to improve water injection and fluid production strategy.

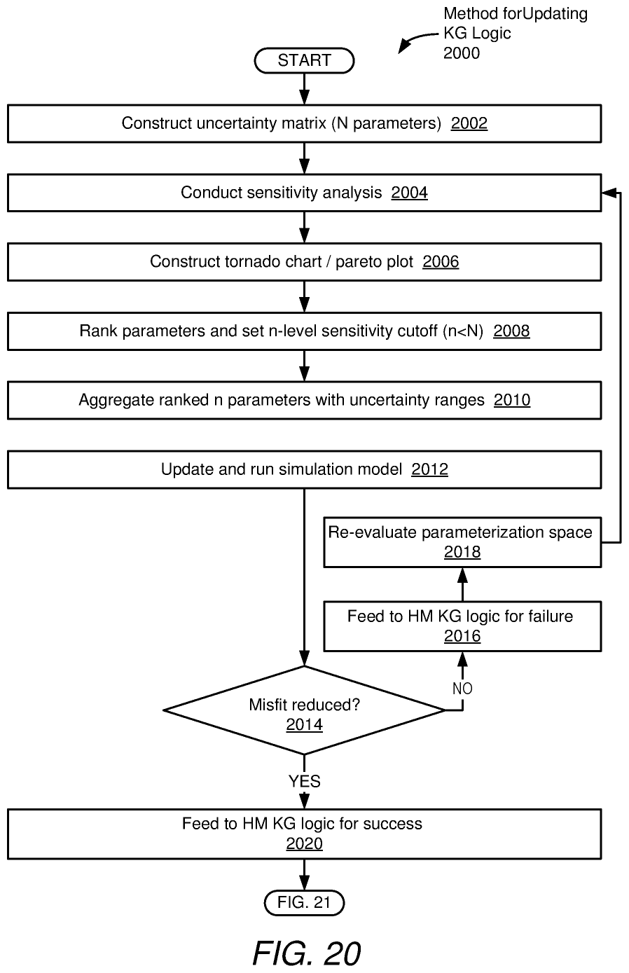

FIG. 15 is a flow diagram of an example of a smart agent process (1500) for artificial lift optimization (ALO), according to some implementations of the present disclosure. The smart agent process (1500) may be implemented, for example, using a field development planning (FDP) agent for ALO (for example, using ALO smart agent (1501), which may perform the following steps).

In Step 1502, the ALO agent retrieves the data from the real-time monitoring system that interactively collects data on ALO system's performance. For example, in the case of electric submersible pump (ESP) equipment, the monitoring system may collect information from the variable speed drive and pressure and temperature sensors at intake and discharge of the pump, liquid rate, temperature. In Step 1504, data filtering and conditioning is performed with a series of algorithms that automatically clean, eliminate spikes, detect frozen data, and estimate the average and standard deviation of the data. Data conditioning functions may include for example: rate of change, range checks, freeze checks, mean and standard deviation, filtering, and stability check. In Step 1506, the ALO agent automatically updates and calculates the new operating point of the ESP, based on the information given at real-time conditions. The agent automatically tunes the model to minimize the error between measured and calculated flow rate and flowing bottom-hole pressure (FBHP) by adjusting unknown parameters, such as skin and ESP wear factor. In Step 1508, the ALO agent uses predictive modeling to predict potential erratic behavior of the ESP system, utilizing short-term predictive machine learning models, such as neural networks and generates proposals for preventive maintenance. In Step 1510, the optimum operating points of the ESP system is calculated, from which the agent automatically select the operating point as the most adequate to the specific operating condition.

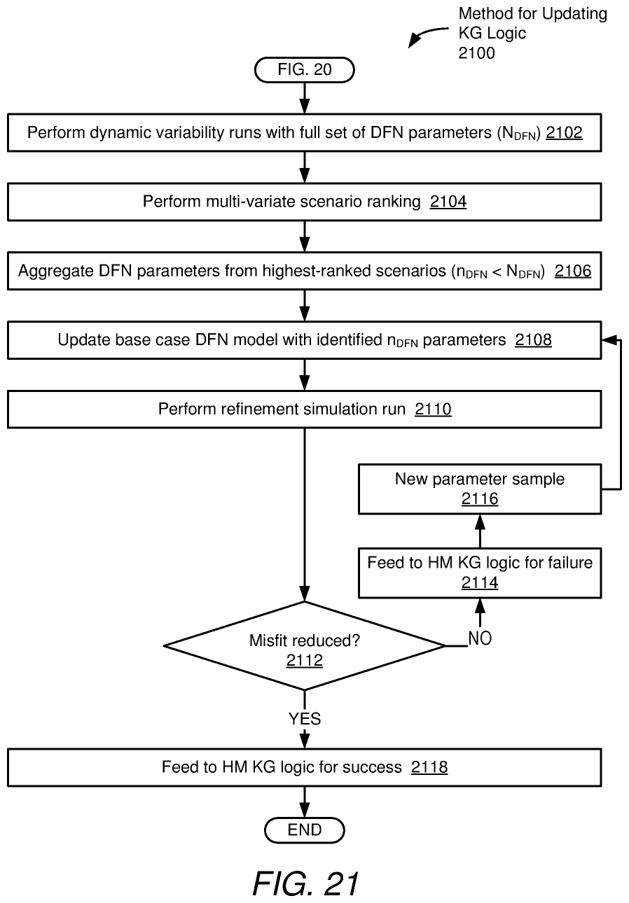

FIG. 16 is a flow diagram of an example of a smart agent process (1600) for probabilistic scenario analysis (PSA), according to some implementations of the present disclosure. The smart agent process (1600) may be implemented, for example, using a risk mitigation agent for probabilistic scenario analysis (PSA) (for example, a PSA smart agent (1601), which may perform the following steps.)

In Step 1602, the real-time well production data is acquired, for example, using connectivity to sensor network systems such as SCADA and IoT. In Step 1604, the agent defines the type of predictive analytics problem evaluated in PSO process. For example, a problem that is related to ESP predictive maintenance scenarios (for example, to identify the potential root-cause variables and attributes that may potentially cause erratic ESP behavior) may be categorized as a classification problem. Alternatively, if an objective is to identify wells with problematic performance in terms of production rates, then the problem may be categorized as a continuous or regression problem. In Step 1606, the agent builds a corresponding predictive model or identifies the model from a library of predefined machine learning (ML) models. In Step 1608, the agent performs training, validation, and prediction with the selected ML model. In Step 1610, the agent recommends actions for well management and maintenance to optimize production. For example, when regression decision trees used as a predictive ML model, individual scenarios leading to the lowest well production may be isolated by automatically tracing a sequence of steps propagating through the nodes and edges of the decision tree. Similarly, the sequence of actions leading to a scenario yielding the highest production may be automatically identified as well.

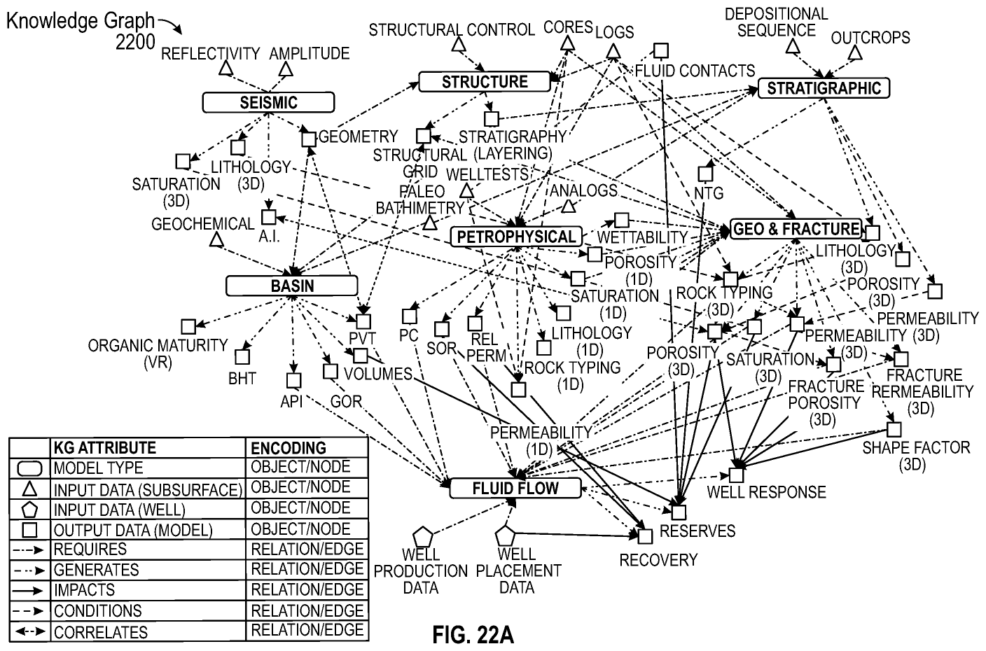

FIG. 17 is a flowchart of an example method (1700) for providing recommendations and advisories using OFs generated from aggregated data received from disparate data sources, according to some implementations of the present disclosure. For clarity of presentation, the description that follows generally describes method (1700) in the context of the other figures in this description. However, it will be understood that method (1700) may be performed, for example, by any suitable system, environment, software, and hardware, or a combination of systems, environments, software, and hardware, as appropriate. In some implementations, various steps of the method (1700) may be run in parallel, in combination, in loops, or in any order.

In Step 1702, source data is received in real-time from disparate sources and in disparate formats. The source data provides information about a facility and external systems with which the facility interacts. The source layer (302), for example, may receive source data from the sources (312a-312f). The disparate formats of the source data may include, for example, structured data, unstructured data, data wrappers, and data wranglers. The facility receiving the source data may be a petroleum engineering facility or a remote facility in communication with the petroleum engineering facility, for example. From Step 1702, the method (1700) proceeds to Step 1704.

In Step 1704, the source data is aggregated to form ontological frameworks. Each ontological framework models a category of components selected from components of a Things category, components of an Events category, and components of a Methods category. Aggregation may occur, for example, in the data aggregation layer (304). The Things category may include, for example, mechanical components including wells, rigs, facilities, sensors, and metering systems. The Events category may include, for example, manual and automated actions performed using the components of the Things category. The Methods category may include, for example, algorithms, workflows, and processes which numerically or holistically quantify the components of the events category. From Step 1704, the method (1700) proceeds to Step 1706.

In Step 1706, an abstraction layer is created based on the ontological frameworks. The abstraction layer includes abstractions that support queries, ontologies, metadata, and data mapping. For example, the data abstraction layer 306 may generate abstractions from the data in the data aggregation layer (304). From Step 1706, the method (1700) proceeds to Step 1708.

In Step 1708, a knowledge discovery layer for discovering knowledge from the abstraction layers is provided. Discovering the knowledge includes graph/network computation, which may provide inputs for graph/network training and validation, which in turn may provide inputs to graph representation learning. From Step 1708, the method (1700) proceeds to Step 1710.

In Step 1710, a recommendation and advisory systems layer is provided for providing recommendations and advisories associated with the facility. The recommendation and advisory systems layer (310), for example, may execute agents such as the reservoir monitoring agent (320a), the surveillance agent (320b), the model calibration agent (320c), the production optimization agent (320d), the field development planning agent (320e), and the risk mitigation agent (320f). After Step 1710, the method (1700) may stop.

In some implementations, method 1700 may further include steps for providing and using a user interface. For example, a user interface built on the recommendation and advisory systems layer (310) may be provided on a computer located at the facility or at a location remote from (but in communication with) the facility. The user interface may display recommendations and advisories generated by the recommendation and advisory systems layer (310), for example. The recommendations and advisories are based on current and projected conditions at a facility, such as information related to equipment, flow rates, and pressures. During interaction by a user using the user interface, a selection may be received from the user of the user interface. Changes to the facility may be automatically implemented based on the selection, such as changes in valve settings or other changes that may affect oil production at the facility.

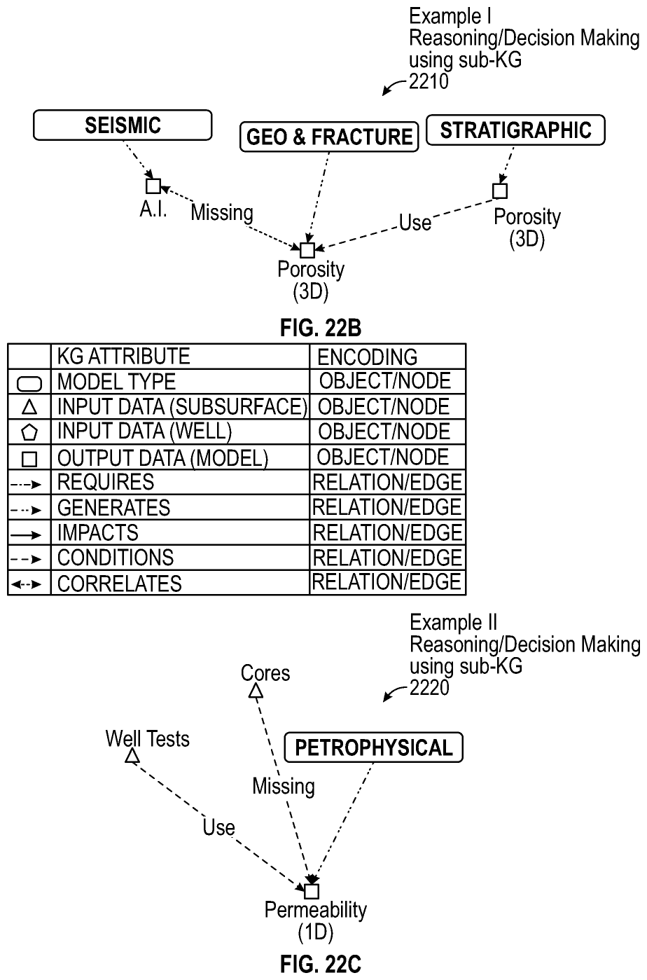

FIG. 18 is a flowchart of an example method (1800) for using aggregation functions to aggregate information for nodes in ontological frameworks, according to some implementations of the present disclosure. For clarity of presentation, the description that follows generally describes the method (1800) in the context of the other figures in this description. However, it will be understood that the method (1800) may be performed, for example, by any suitable system, environment, software, and hardware, or a combination of systems, environments, software, and hardware, as appropriate. In some implementations, various steps of the method (1800) may be run in parallel, in combination, in loops, or in any order.

In Step 1802, aggregation functions are defined for ontological frameworks modeling categories of components of a facility. Each aggregation function defines a target component selected from a Things category, an Events category, and a Methods category. Defining the target component includes aggregating information from one or more components selected from one or more of the Things category, the Events category, and the Methods category. For example, the aggregation functions described with reference to FIG. 7 may be defined. Examples of events and methods that may be used in aggregations are listed in Table 3. From Step 1802, the method (1800) proceeds to Step 1804.

In Step 1804, source data is received in real-time from disparate sources and in disparate formats. The source data provides information about the components of the facility and external systems with which the facility interacts. The disparate formats of the source data may include, for example, structured data, unstructured data, data wrappers, and data wranglers. As an example, the source layer (302) may receive source data from the sources (312a-312f). From Step 1804, the method (1800) proceeds to Step 1806.

In Step 1806, using the aggregation functions, the source data is aggregated to form the ontological frameworks. Each ontological framework models a component of the Things category, a component of the Events category, or a component of the Methods category. For example, the description of FIG. 9B describes a network showing aggregations. After Step 1806, the method (1800) may stop.

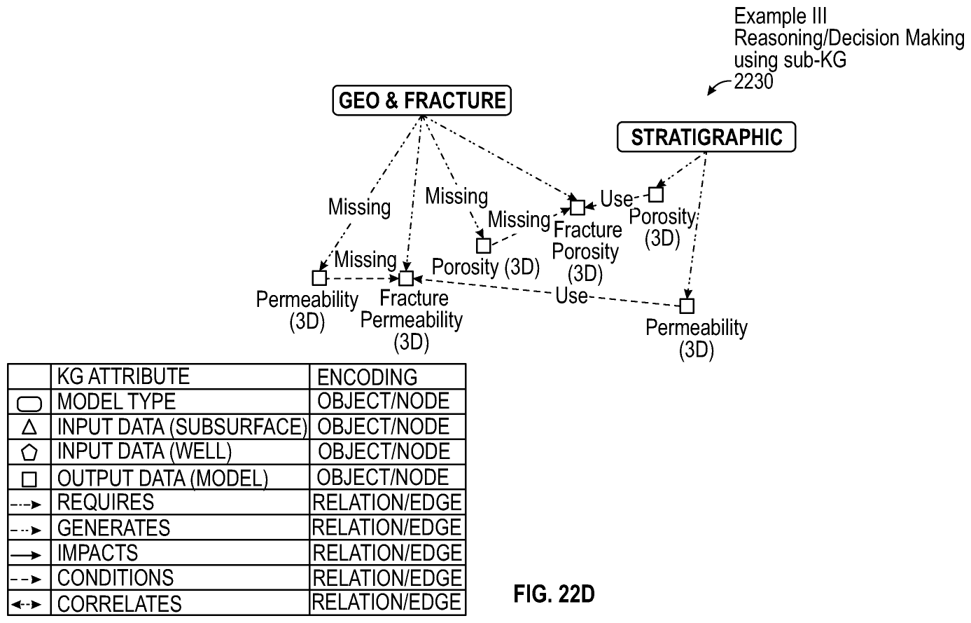

FIG. 19 shows a method (1900) implementing an intelligent and automated recommender system based on a reservoir simulation history matching and field development planning knowledge graphs (KG).

One or more steps of the method may be performed by one or more components (e.g., recommender system (160) as described in FIG. 1, and/or systems (200) and (300) of FIGS. 2 and 3A. While the various steps in FIG. 19 are presented and described sequentially, one of ordinary skill in the art will appreciate that some or all of the steps may be executed in different orders, may be combined or omitted, and some or all of the blocks may be executed in parallel. Furthermore, the steps may be performed actively or passively.

The calibration of reservoir simulation models to dynamic field production data, commonly referred to as history matching (HM), is perceived as one of the most time consuming and computationally intensive engineering processes in reservoir validation. The task of dynamic model reconciliation becomes even more challenging in the presence of reservoir structural complexities (e.g., fractures) and intrinsic subsurface uncertainty. Additionally, the subsequent step of optimum field development planning (prediction) is even more complex, as it involves several variables. Reservoir field depletion strategy (natural depletion, water injection, gas injection etc.), well types and orientation, well count, well and field level operations are a few among the many variables. The method described in reference to FIG. 19 and other subsequently discussed figures provides an intelligent and automated recommender system based on a reservoir simulation history matching and field development planning KG, in accordance with embodiments of the disclosure. The KG is generated using complex spatio-temporal reservoir simulation data built on an ontology that is created by subject matter experts with the help of intelligent machine learning algorithms and constantly being updated that learns from experiences of simulation engineers and captures this knowledge in the form of rules and relationships. The ontology, which provides a semantic middleware layer, is updated consistently based on new learnings which could entail custom unique learnings as engineers are conducting simulation studies. This enables the digital capturing and retention of newly acquired knowledge. Data are then inferred to regenerate the updated KG where the data will reflect the new relationships and rules. The KG is then supplemented with a Graphical User Interface (GUI) that enables a seamless interaction with the KG. The framework described in reference to FIG. 19 includes aspects as previously described. The framework further includes additional aspects that are discussed in detail below.

In one or more embodiments, an initial ontology is built based on general reservoir simulation rules and relationships. A knowledge graph (KG) is created by inferring available (prior) data representing reservoir simulation models. Node types, relation types, node embeddings (features) and node-to-node interaction agents (semantic taxonomy, queries) are encoded. These operations may be performed as previously described in reference to various figures.

In one or more embodiments, an intelligent, automated, content-based history matching and field development recommender system (HMFDRS) is implemented, based on predictive reasoning over KGs (one-hop, path, conjunctive) using machine learning (ML) classifiers. Recommendations for model parameterization and decision chain may be generated, guided by multi-objective global optimization for dynamic model reconciliation and update These operations may be performed as previously described in reference to various figures, in particular, for example, FIGS. 13 and 17.

Further, in one or more embodiments, a continuous (live) HMFDRS logic completeness update based on sourcing failure/success classification, evaluated via simulation model optimization, is incorporated. The details of the related operations are described below. By leveraging the continuous logic completeness update and encoding new information, the HMFDRS efficiently generalizes predictive ML classifiers over the domain of reservoir subsurface model uncertainty and dynamic variability.

In summary, the described method may be used as an automated computational framework for a KG-based history matching and field development recommender system (HMFDRS) to assist with simulation model reconciliation, dynamic update and history matching under reservoir parameter uncertainty, and may further be used for optimized field development, based on the HM model.

While the following paragraphs introduce a logic completeness update for a history matching and field development recommender system, similar logic completeness updates may be performed for any other knowledge graph-based operations of a petroleum engineering system.

Turning to the flowchart of FIG. 19, a method for history matching and making recommendations for field development, in accordance with one or more embodiments, is shown. A reservoir simulation taxonomy/ontology is assumed to be available at the time of the execution of the described method. The reservoir simulation taxonomy/ontology may have been built using machine learning and subject matter experts based on public domain knowledge, e.g., as previously described. Data from the database has already been inferred to results in a knowledge graph. Further, the recommender system is assumed to be able to access the knowledge graph to query the knowledge graph and return answers swiftly, e.g., as schematically illustrated in FIG. 3A.

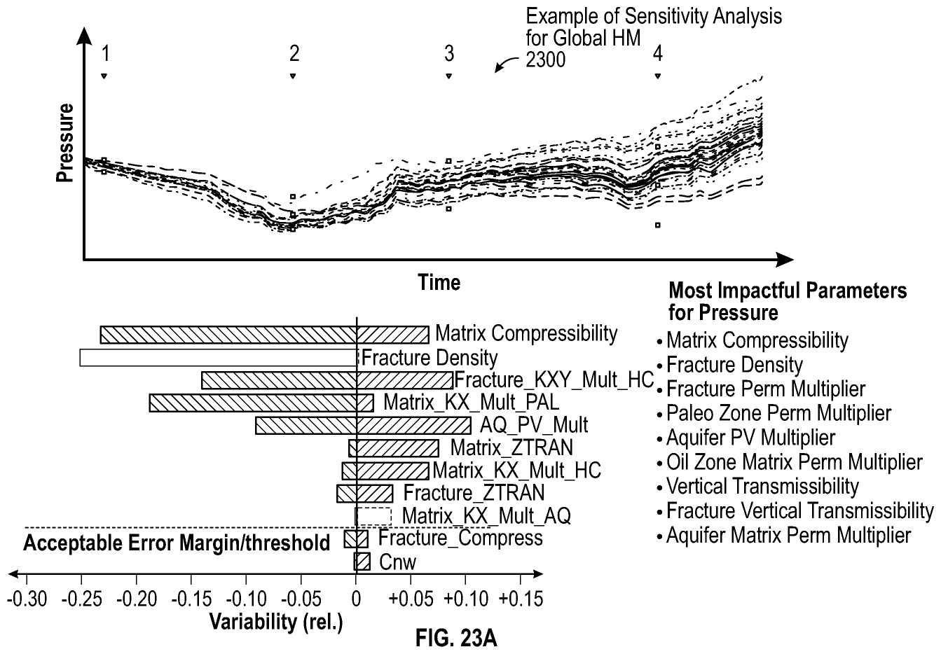

In Step 1902, a selection of a reservoir simulation model is obtained. Examples for reservoir simulation models that may be selected include, for example, a seismic model, a basin model, a stratigraphic model, etc. Examples of reservoir simulation models are provided in the knowledge graph of FIG. 22A. The selection of the reservoir simulation model may be made by a user, e.g., a reservoir engineer, for example, because the reservoir simulation model outputs are needed (e.g. for HM or for field development purposes). The selected reservoir simulation model may include a single model or a plurality of models, encapsulated in the form of statistically diverse ensemble of simulation models under reservoir parameter uncertainty. The source of these simulation models may be in any format such as simulation model files, may be stored in a database, etc. The described method is able to handle the ingestion of data from different type of sources, e.g., as described in reference to FIG. 3A.

In Step 1904, based on the selection obtained in Step 1902, the corresponding baseline reservoir simulation model is selected or referenced for parameterization. The parameterization may be based on engineering criteria and data maturity. For example, the criteria for the parameterization may be determined based on engineering judgment and the assessment of how representative and complete the data are for building the knowledge graph. Specifically, the data completeness determines an important threshold: when data are sparse or missing, the rules for predictive query reasoning are burdened with high/unacceptable uncertainty. Data not already available in the knowledge graph (KG) currently associated with the baseline reservoir simulation model are ingested and inferred, e.g., using the components of a system as shown in FIG. 3A.

In Step 1906, the ontology and the KG is encoded, based on the available data. Logic rules of inference and implication, pertaining to history matching (HM), prediction and dynamic update of the baseline simulation model(s) KG is encoded using node embeddings (features) and node-to-node interaction agents (semantic taxonomy, queries), using techniques as previously described. There operations may be performed as previously described. An example of a possible resulting KG is shown in FIG. 22A.

In Step 1908, the KG logic is examined for completeness. In one embodiment, the set of HM logic rules of inference and implication are evaluated for completeness, based on the ability to render a statistically accurate success/failure decision or prediction. In other words, Step 1908 performs a test to determine whether the KG logic includes the decision information needed to execute a simulation model with a desired outcome (e.g., accuracy). Decision tree-based ML models, such as classification and regression trees (CART) or ensemble learning (random forest, RF) or any other models may be used. Examples are provided in FIGS. 22B-22F. The evaluation of regression models (where the response variable is of continuous nature) may be performed using metrics such as accuracy or loss of the trained model, defined with, e.g., means square error (MSE). During training, the objective may be to minimize the loss using an optimization process. For classification models (where the response variable is of categorical nature) the sensitivity/specificity (i.e., attributes of, for example, a confusion matrix) metrics may be used as well as the ROC (receiver operating characteristic curve), which essentially gives a true positive rate as a function of false positive rate, of the classifier. In addition, one may use the AUC (area under the curve) attribute of the ROC curve to evaluate the classifier. For both, regression and classification problems, k-fold cross validation may be used to estimate the skill (prediction accuracy) of the model on new/unseen data sets. Each of the above criteria may be used to determine completeness. A performance threshold may be set, and if the performance of a model exceeds the threshold, this may indicate completeness.

In Step 1910, if the KG logic was found to be incomplete, the method may proceed with the execution of Step 1912. If the KG logic was found to be complete, the method may proceed with the execution of Step 1914.

The following Steps 1914-1920 may be performed to obtain decision/prediction information needed to execute the simulation model in Step 1922. Each step is subsequently described.

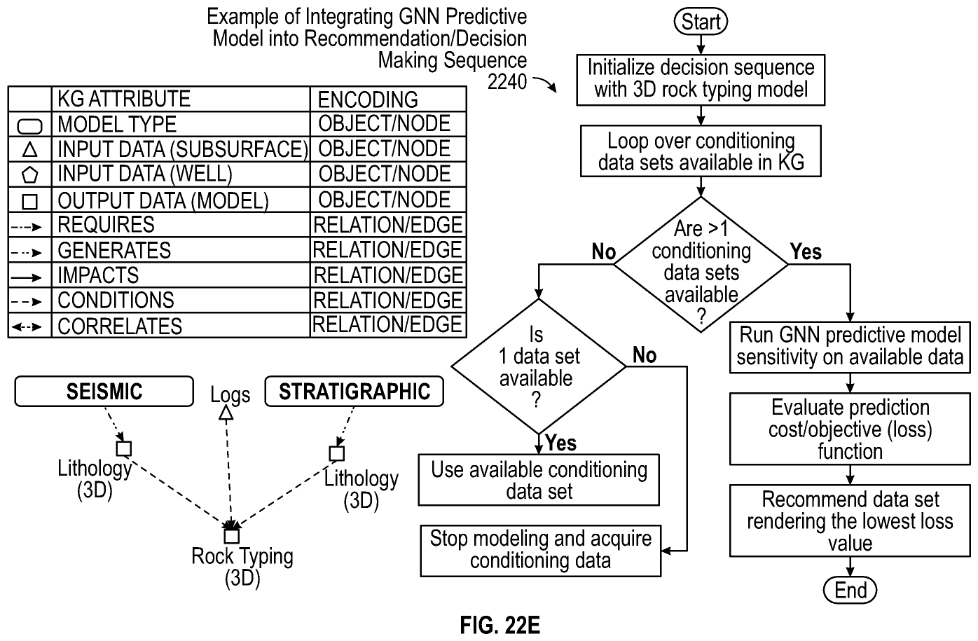

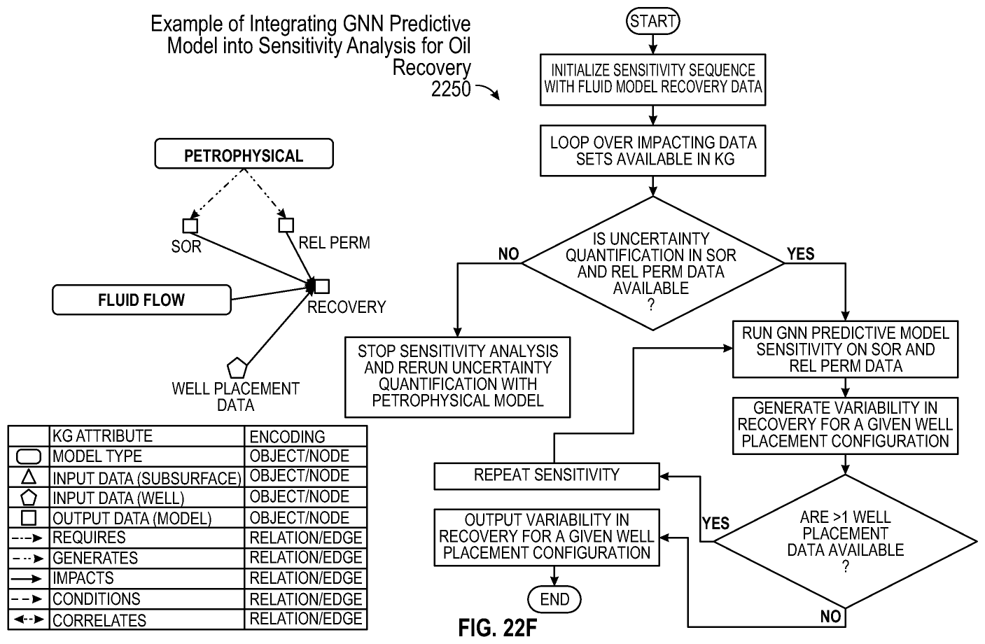

In Step 1912, the KG logic is updated as described below in reference to FIGS. 20 and 21.

In Step 1914, a predictive query reasoning over the KGs may be performed. Methods such as one-hop, path, conjunctive and/or box embeddings may be used, e.g., to predict a previously unknown element of the KGs, thereby potentially increasing the comprehensiveness of available information. For example, an embeddings approach that embeds a KG into vectors may be used to perform generalizations that result in new facts that were not available in the initial KGs and/or in the underlying ontologies. Those skilled in the art will appreciate that standard methods of machine learning in knowledge graphs may be used in order to perform Step 1914.

In Step 1916, the decision/prediction information of Step 1914 is aggregated as a recommendation of decision steps or sequences based on a minimized misfit objective function, defined for example as Least Squares (LSQR) misfit between simulated and observed data, represented in deterministic or probabilistic (Gaussian) form. An example illustrating the execution of Step 1916 is provided in FIG. 22E.

In Step 1918, it is determined whether the history matching objective (minimization of misfit function within given tolerances) is achieved. For example, it may be determined whether a field and/or well-level pressure and/or a liquid production matches one or more predefined engineering acceptance criteria.

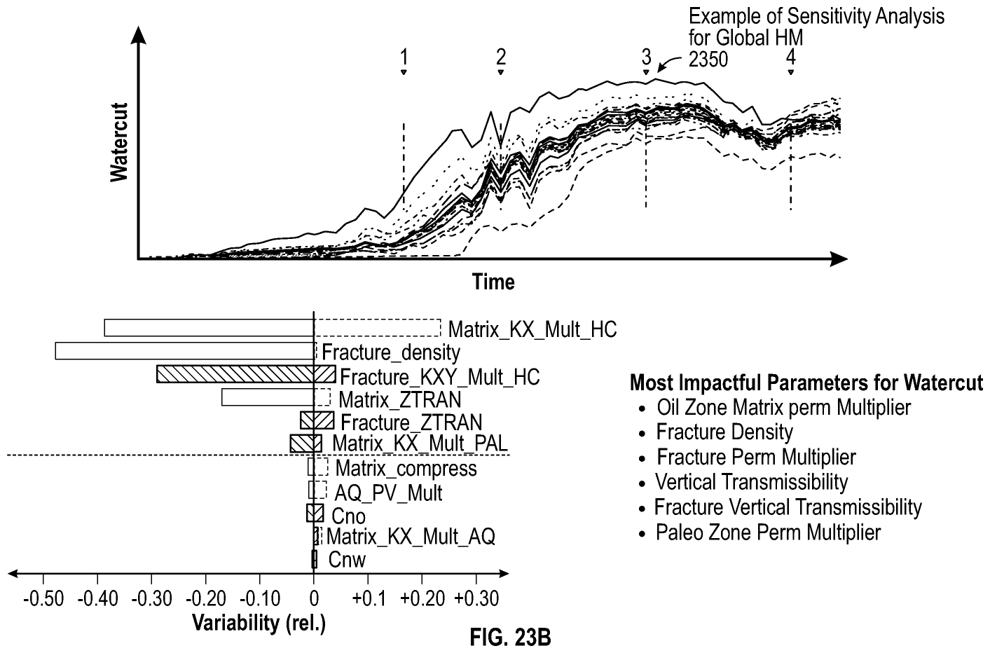

In Step 1920, if the history matching objective has not been met, the sequence of reasoning queries is statistically re-evaluated (for prediction accuracy and precision), the predictive query reasoning is automatically reiterated, and the execution of the method may subsequently proceed with Step 1914. In one embodiment, a sensitivity analysis is used to perform Step 1920. Now referring to FIG. 23A in order to describe Step 1920 based on an example, by inspection of the tornado chart generated in the sensitivity analysis, a simple sequence of recommended HM steps would unfold as a top-down parameterization approach (since the highest ranking variable in the tornado chart renders the most variability). In the example of FIG. 23A, this would be the matrix compressibility which affects the field pressure response the most) The following steps may be performed: a) the highest-ranked variable as identified in tornado chart is selected, b) a simulation is performed based on the selection, c) the misfit objective function is evaluated, d1) if the misfit falls within an acceptable tolerance, the process ends, d2) if the misfit exceeds the acceptable tolerance, variables a sequentially added and the above steps are repeated. The process may be repeated until the misfit is within the acceptable tolerance.

In Step 1922 the aggregated decision/prediction information is used to execute the simulation model. The execution of Step 1922, in one or more embodiments, ensures that the simulation model, selected in Step 1902, is executed in an optimal manner. An example of operations that may be conditionally executed is shown in FIG. 22E. In the example, the conditional execution ensures that the model is executed to produce a minimal misfit.

The results of the execution of Step 1922 may be used to operate a PE system. For example, simulation results and/or predictions may be used to update drilling parameters, production parameters, etc.

Turning to the flowchart of FIG. 20, a method (2000) for updating a KG logic, in accordance with one or more embodiments, is shown.

In Step 2002, an uncertainty matrix of reservoir subsurface and simulation model parameters is constructed based on underlying engineering knowledge and interpretation. The uncertainty matrix may include a list of reservoir subsurface and simulation parameters with associated uncertainty tolerances/intervals. An example of such parameters is shown in Table 4, below. Any number of parameters, e.g., N parameters, may be considered. The uncertainty matrix may be compiled with an overall model HM and update of the HM in mind. In other words, the uncertainty matrix embodies parameters that impact the global HM process as well as HM refinement (discussed below in reference to FIG. 21). While this discussion of Step 2002 related to a particular uncertainty matrix for reservoir subsurface modeling and simulation, other uncertainty matrices may be generated, depending on the problem at hand.

TABLE 4
Example of Uncertainty Matrix

| | | Parameterization |
|---|---|---|
| Variable/Parameter | Main Impact | Domain |
| Aquifer permeability | Pressure, watercut | Region |
| Aquifer pore volume | Pressure | Region |
| Oil zone matrix permeability | Pressure, watercut | Region |
| Paleo-zone matrix permeability | Pressure, watercut | Region |
| Compressibility - Matrix | Pressure | Field |
| Matrix vertical transmissibility | Pressure, watercut | Region |
| Fracture vertical transmissibility | Pressure, watercut | Region |
| Relative permeability (oil-water) | Water break-through | Field/Rock type |
| Oil zone fracture density | Pressure, watercut | Region |
| Paleo zone fracture density | Pressure, watercut | Region |
| Oil zone fracture permeability | Pressure, watercut | Region |
| Paleo zone fracture permeability | Pressure, watercut | Region |

In Step 2004, based on the uncertainty matrix, a model parameterization scheme is designed and sensitivity analyses are conducted. An example of a model parameterization scheme is shown in Table 5. Methods such as One Variable at a Time (OVAT) may be used to perform Step 2004. A full physics reservoir simulator or a form of proxy simulator/estimator may be used to evaluate the dynamic response. If the uncertainty quantification process is defined as Bayesian inference, the dynamic response may be referred to as likelihood term of Bayesian representation. To minimize statistical biasing during probabilistic sampling, the HM KG Logic may also be updated with the information on the statistical distribution (probability density function) used for sampling, to maximize statistical fitness and data transformation/mapping techniques used to maintain uniform sampling across data spread with several orders of magnitude.

TABLE 5
Parameterization Scheme

| Parameter | Minimum | Maximum | Most likely | Distribution | Transform |
|---|---|---|---|---|---|
| AQ_PV_Mult | 0.10 | 10.00 | 1.00 | Uniform | SQRT |
| Cno | 4.00 | 6.00 | 5.00 | Uniform | Linear |
| Cnw | 2.00 | 4.00 | 3.00 | Uniform | Linear |
| Fracture_KXY_Mult_HC | 0.10 | 10.00 | 1.00 | Gauss | Log |
| Fracture_compress | 0.00 | 0.00 | 0.00 | Uniform | Linear |
| Fracture_ZTRAN | 0.00 | 0.10 | 0.01 | Uniform | Log |
| Fracture_density | 500.00 | 4000.00 | 500.00 | Uniform | Linear |
| Krg | 1.00 | 3.00 | 2.00 | Uniform | Linear |
| Krw | 0.50 | 0.70 | 0.60 | Uniform | Linear |
| Matrix_KX_Mult_AQ | 0.10 | 10.00 | 1.00 | Log_norm | Log |
| Matrix_KX_Mult_HC | 0.10 | 10.00 | 1.00 | Log_norm | Log |
| Matrix_KX_Mult_PAL | 0.10 | 10.00 | 1.00 | Log_norm | Log |
| Matrix_compress | 0.00 | 0.00 | 0.00 | Uniform | Linear |
| Matrix_ZTRAN | 0.00 | 0.10 | 0.01 | Uniform | Log |

In Step 2006, as a result of the sensitivity analyses (e.g., using OVAT methods), dynamic variability and tornado chart or pareto front plot are constructed and the set of most impactful parameters is deduced based on the acceptable error margin/threshold. Examples are provided in FIGS. 23A and 23B. In addition to estimated boundaries of dynamic response variability for HMFDRS recommendations, the interpretation of tornado chart information may provide valuable information for encoding the logic rules of inference. Positive and negative response-parameter correlation may be observed. In dynamically highly complex, multi-variate systems, such as reservoir simulation models, the response-parameter correlation may be non-linear. As a result, the dynamic response to most-likely parameter values may fall outside of (min-max) boundaries. In such situations, the predictive/recommendation capacity of HMFDRS may be further improved by encoding parameter cross-correlation and/or covariance arrays into KG's logic rules of inference.

In Step 2008, an n-level sensitivity cutoff is performed, with n<N, where N represents the full set of uncertain parameters and n represents the subset of most important parameters, ranked based on their impact on dynamic model response (e.g., reservoir pressure, reservoir watercut, etc.)

In Step 2010, a parameterization scheme is designed based on the subset of n parameters, with re-evaluated uncertainty ranges. The parameterization scheme is used in preparation for running an updated reservoir simulation, in Step 2012.

In Step 2012, the reservoir simulation runs are conducted using a full physics reservoir simulator or a form of proxy simulator/estimator to evaluate the dynamic response.

In Step 2014, a multi-objective function, represented as a least squares (LSQR) misfit between simulated and observed data is evaluated within the assigned tolerances for acceptable accuracy. If the misfit is not reduced, the execution of the method may proceed with Step 2016. If the misfit is reduced, the execution of the method may proceed with Step 2020.

In Step 2016, if the misfit is not reduced, the history matching KG logic for failure is fed into the HMFDRS framework to update KG logic for completeness, as the execution of the method of FIG. 19 proceeds from Step 1912 to Step 1908. In one or more embodiments the KG logic represents an exhaustive library or sequence of steps related to reservoir engineering tasks. The KG logic may include KG logic for both success and failure. The KG logic for failure, updated in Step 2016, may represent an exhaustive library or sequence of steps that lead to an increase of a (global) misfit objective function, in other words, divert the optimization process from convergence (i.e. minimization of misfit/loss). One simple practical example is a stochastic sampling using a Monte Carlo (MC) method with Metropolis-Hastings sampler: the related knowledge base for HMFDRS would identify and sequentially accumulate all the sampling steps that lead to the increase of misfit likelihood, gathered across the model uncertainty domain (multiple model realizations, risk mitigation scenarios, etc.). Once such a library (or exhaustive KG) is compiled, per specific reservoir engineering task, it may be sampled continuously by the HMFDRS to render recommendations of “what not to do”.

In Step 2018, the parameterization space is reevaluated in preparation for repeating the execution of Step 2004. The reevaluation may be performed as described for Step 2002

Step 2020, if the misfit is reduced and HM improved, the history matching KG logic for success is fed into HMFDRS framework to update the KG logic for completeness as the execution of the method of FIG. 19 proceeds from Step 1912 to Step 1908. Subsequently, the method proceeds with the execution of additional steps described in FIG. 21. The updating in Step 2020 may be performed analogous to the updating of Step 2016, although for a successful reduction of the misfit. Based on the operations of Step 2020, the KG logic for success may eventually include a representative library of process steps, leading to misfit likelihood reduction, which can be compiled for HMFDRS to render recommendations of what to do.

Turning to the flowchart of FIG. 21, a method (2100) for updating a KG logic, in accordance with one or more embodiments, is shown.

For the following description of the method of FIG. 21, assume that, following the analyses and interpretation of model response sensitivity conducted in Step 2004 of FIG. 20, the parameters of the discrete fracture model/network (DFN) in a dual porosity-dual permeability model (DPDP) have been identified as the most impactful for the dynamic pressure and watercut response at the individual-well level of the HM process. Therefore, the steps of refinement HM sub-process described in FIG. 21 are applied to the re-parameterization and optimization of the DFN model. Those skilled in the art will appreciated that in a generalized implementation of the HMFDRS framework, the refinement sub-process may be attributed to alternative model parameterization, e.g., high-permeability streaks or flow units in single porosity-single permeability (SPSP) model based on incorporation of PLT flow profiles, etc.

In Step 2102, a series of dynamic variability runs is performed by stochastically sampling the full set of DFN parameters, NDFN. An example of a parameterization scheme is shown in Table 6. The parameterization scheme incorporates the list of parameters included in the uncertainty matrix with associated tolerances for probabilistic sampling. The uncertainty range is represented as an interval from which the DFN parameter is probabilistically sampled using a random (ran) sampler.

TABLE 6
Parameterization Scheme for DFN Model

| | Uncertainty | |
|---|---|---|
| Parameter | Range | |
| Variogram_Major | ran(1000, 5000) | Parameterization of |
| Variogram_Minor | ran(100, 500) | fracture orientation |
| Variogram_Vertical | ran(10, 50) | |
| Fracture_Length_Median | ran(2000, 3000) | Parameterizatio of DFN |
| Fracture_Length/Height | ran(10, 100) | geometric properties |
| Fracture_Density | ran(500, 4000) | Parameterization of |
| | | fracture density |
| Fracture_Length_Min | ran(1000, 3000) | Parameterization of DFN |
| Fracture_Length_Max | ran(4000, 6000) | geometric constraints |
| Fracture_perm_scal- | ran(1, 10) | Parameterization of |
| ing_factor | | fracture permeability |
| Friction_angle | ran(10, 50) | model |
| Fracture_aperture | ran(10, 50) | |

In Steps 2104, a multi-variate ranking of conducted variability runs is performed, and highest-ranked scenarios are identified. Here the highest ranked scenarios may be scenarios that render a misfit objective function lower than an acceptable accuracy residual or threshold.

Step 2106, by interpreting the results of the sensitivity analyses (e.g., as shown in FIGS. 23A, 23B), the subset of the most important DFN parameters (n_{DFN}<N_{DFN}) is aggregated. The subset may include the DFN parameters with the highest impact on the model dynamic response (pressure, watercut). In one example, Step 2106 identifies the fracture density, lateral fracture permeability and fracture vertical transmissibility as most impactful parameters.

In Step 2108, the basecase DFN model is updated with identified n_{DFN} parameters, and in Step 2110, a refinement simulation run is performed, after the updating.

In Step 2110, a multi-objective function, represented as LSQR misfit between simulated and observed data is evaluated within the assigned tolerances for acceptable accuracy.

In Step 2112, it is determined whether the misfit has been reduced.

In Step 2114, if the misfit has not been reduced, the history matching KG logic for failure is fed into the HMFDRS framework to update the KG logic for completeness, as the execution of the method of FIG. 19 proceeds from Step 1912 to Step 1908.

In Step 2116, the parameterization space is reevaluated, and the execution of the method may then continue by repeating Step 2108 and subsequent steps with the updated parameterization space.

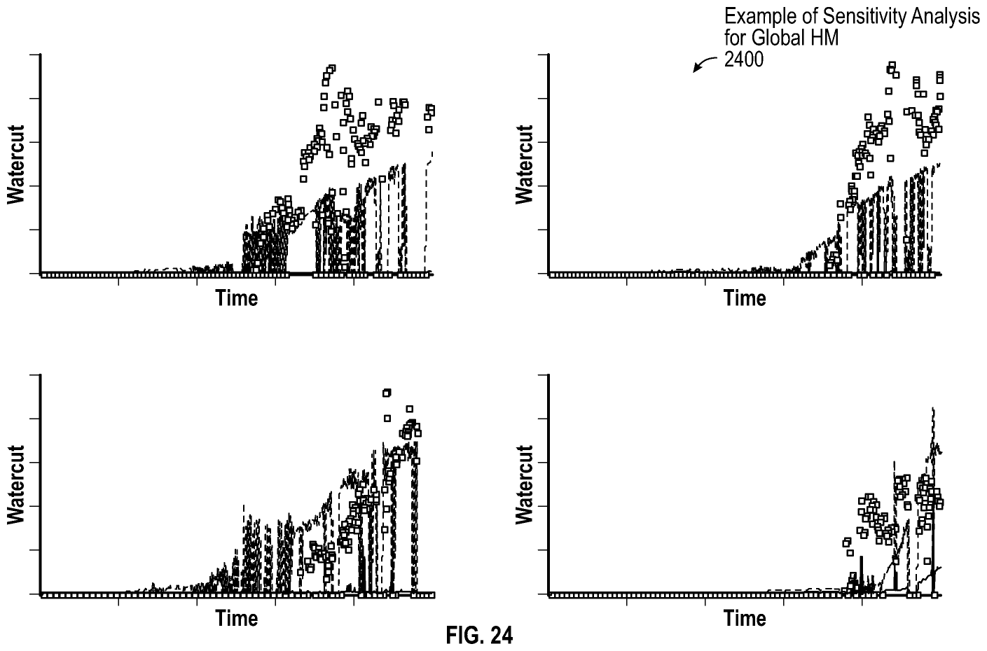

In Step 2118, if the misfit has been reduced, the history matching KG logic for success is fed into HMRS framework to update KG logic for completeness as the execution of the method of FIG. 19 proceeds from Step 1912 to Step 1908. An example for a refined well-level history match is provided in FIG. 24.

FIG. 22A shows an example of a KG, in accordance with one or more embodiments. As shown, the KG (2200) includes seismic models, structure models, stratigraphic models, basin models, petrophysical models, geo& fracture models, and fluid flow models. The KG (2200) further includes input and output data associated with the models, and establishes relationships between models, input, and/or output data.

FIG. 22B shows an example of reasoning/decision making using sub-KGs. In the example (2210), a 3D porosity model is to be built. A seismic model outputs an acoustic impedance, a geo&fracture model outputs a 3D porosity, and a stratigraphic model also outputs a 3D porosity. In the example, the spatial correlation between acoustic impedance and 3D porosity obtained from the geo&fracture model is missing. However, since 3D porosity is also available from the stratigraphic model, the 3D porosity output of the stratigraphic model may be relied upon instead.

FIG. 22C shows an example of reasoning/decision making using sub-KGs. In the example (2220), a 1D permeability is to be determined. A petrophysical model provides the needed output, but no conditioning data are available from the cores input data. In the example, the conditioning data may be obtained using the well tests data instead.

FIG. 22D shows an example of reasoning/decision making using sub-KGs. In the example (2230), geo&fracture model and a stratigraphic model provide multiple outputs. However, the outputs of the geo&fracture model are incomplete. The missing 3D permeability and 3D porosity are substituted using the corresponding outputs of the stratigraphic model.

FIG. 22E shows an example of integrating a GNN predictive model into a recommendation/decision making sequence. In the example (2240), a 3D rock typing output requires two inputs, including a 3D lithology input and a logs input. If the seismic model and the stratigraphic model are successfully executed, both may provide a 3D lithology. As the flowchart illustrates, the recommendation/decision making sequence may executed differently, depending on whether no, one, or two sets of 3D lithology data are available. Specifically, the modeling may terminate if no 3D lithology data are available. If one set of 3D lithology data is available, that set of lithology data may be used for the modeling of the 3D rock typing data. If both sets of 3D lithology data are available, the data set that turns out to produce more accurate results may be used. The flowchart shown in FIG. 22E is the result of executing the steps of the methods of FIGS. 19, 20 and 21.

FIG. 22F shows an example of integrating a GNN predictive model into a sensitivity analysis for oil recovery. In the example (2250), the recovery is an output of the fluid flow model. However, the recovery is impacted by well placement, and two outputs of the petrophysical model “Sor” (remaining oil saturation), and “Rel Perm” (relative permeability). As the flowchart illustrates, a sensitivity analysis may be performed to determine the effect of “Sor” and “Rel Perm” on the recovery. The result may be different, depending on whether quantifications of the uncertainty for “Sor” and “Rel Perm” are available. No sensitivity analysis is performed if quantifications are unavailable. If the quantifications are available, the sensitivity analysis may be performed for any number of well sites. The flowchart shown in FIG. 22F is a simplified representation of a subset of steps of the methods of FIGS. 19, 20 and 21.

FIG. 23A shows an example of a sensitivity analysis for pressure global HM, in accordance with one or more embodiments. In the example (2300), a pressure dynamic variability with designated four sensitivity estimator points, with a tornado chart (calculated at estimator point 2), is shown, including a designated acceptable variability error margin/error and a list identifying the most impactful parameters. The solid red/blue bars correspond to positive (linear) response-parameter correlation, resulting in increased response with increased parameter value, and vice versa. The empty bars on the other hand, indicate the negative (linear) response-parameter correlation, resulting in increased response with reduced parameter value, and vice versa.

FIG. 23B shows an example of a sensitivity analysis for watercut global HM, in accordance with one or more embodiments. In the example (2350), a watercut dynamic variability with designated four sensitivity estimator points, with a tornado chart (calculated at estimator point 2), is shown, including a designated acceptable variability error margin/error and a list identifying the most impactful parameters. The solid red/blue bars correspond to positive (linear) response-parameter correlation, resulting in increased response with increased parameter value, and vice versa. The empty bars on the other hand, indicate the negative (linear) response-parameter correlation, resulting in increased response with reduced parameter value, and vice versa.

FIG. 24 provides an example (2400) of an improved well-refined watercut HM for four arbitrarily selected wells, in accordance with one or more embodiments. The subsequently discussed improvement in watercut match is achieved by updating a Discrete Fracture Network (DFN) model using the previously described methods.

Based on the logic rules of inference embedded in the KG, the DFN parameterization scheme proposed for refinement HM (Table 6) and results of sensitivity/variability analyses with encoded interpretation of tornado charts (see FIG. 23B) the HMFDRS framework (FIG. 19) may recommend the following sequence of steps for DFN model update to achieve the improvement refined well watercut history match, as indicated in FIG. 24:
To increase well(s) watercut in the region of interest by 48%, reduce base case fracture density (i.e. increase friction angle as per Table 6) by 2%.
To increase well(s) watercut in the region of interest by 3%, increase fracture permeability (i.e. increase scaling/multiplication factor as per Table 6) by 17%; to reduce well(s) watercut in the region of interest by 28%, reduce fracture permeability (i.e. reduce scaling/multiplication factor as per FIG. 8) by 13%
To increase well(s) watercut in the region of interest by 5%, increase fracture vertical transmissibility by factor of 140; to reduce well(s) watercut in the region of interest by 3%, reduce fracture vertical transmissibility by factor of 3.

Embodiments may be implemented on a computer system. FIG. 25 is a block diagram of a computer system (2502) used to provide computational functionalities associated with described algorithms, methods, functions, processes, flows, and procedures as described in the instant disclosure, according to an implementation. The illustrated computer (2502) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (2502) may include a computer that includes an input device, such as a keypad, keyboard, touch screen, or other device that can accept user information, and an output device that conveys information associated with the operation of the computer (2502), including digital data, visual, or audio information (or a combination of information), or a GUI.

The computer (2502) can serve in a role as a client, network component, a server, a database or other persistency, or any other component (or a combination of roles) of a computer system for performing the subject matter described in the instant disclosure. The illustrated computer (2502) is communicably coupled with a network (2530). In some implementations, one or more components of the computer (2502) may be configured to operate within environments, including cloud-computing-based, local, global, or other environment (or a combination of environments).

At a high level, the computer (2502) is an electronic computing device operable to receive, transmit, process, store, or manage data and information associated with the described subject matter. According to some implementations, the computer (2502) may also include or be communicably coupled with an application server, e-mail server, web server, caching server, streaming data server, business intelligence (BI) server, or other server (or a combination of servers).

The computer (2502) can receive requests over network (2530) from a client application (for example, executing on another computer (2502)) and responding to the received requests by processing the said requests in an appropriate software application. In addition, requests may also be sent to the computer (2502) from internal users (for example, from a command console or by other appropriate access method), external or third-parties, other automated applications, as well as any other appropriate entities, individuals, systems, or computers.

Each of the components of the computer (2502) can communicate using a system bus (2503). In some implementations, any or all of the components of the computer (2502), both hardware or software (or a combination of hardware and software), may interface with each other or the interface (2504) (or a combination of both) over the system bus (2503) using an application programming interface (API) (2512) or a service layer (2513) (or a combination of the API (2512) and service layer (2513). The API (2512) may include specifications for routines, data structures, and object classes. The API (2512) may be either computer-language independent or dependent and refer to a complete interface, a single function, or even a set of APIs. The service layer (2513) provides software services to the computer (2502) or other components (whether or not illustrated) that are communicably coupled to the computer (2502). The functionality of the computer (2502) may be accessible for all service consumers using this service layer. Software services, such as those provided by the service layer (2513), provide reusable, defined business functionalities through a defined interface. For example, the interface may be software written in JAVA, C++, or other suitable language providing data in extensible markup language (XML) format or other suitable format. While illustrated as an integrated component of the computer (2502), alternative implementations may illustrate the API (2512) or the service layer (2513) as stand-alone components in relation to other components of the computer (2502) or other components (whether or not illustrated) that are communicably coupled to the computer (2502). Moreover, any or all parts of the API (2512) or the service layer (2513) may be implemented as child or sub-modules of another software module, enterprise application, or hardware module without departing from the scope of this disclosure.

The computer (2502) includes an interface (2504). Although illustrated as a single interface (2504) in FIG. 25, two or more interfaces (2504) may be used according to particular needs, desires, or particular implementations of the computer (2502). The interface (2504) is used by the computer (2502) for communicating with other systems in a distributed environment that are connected to the network (2530). Generally, the interface (2504 includes logic encoded in software or hardware (or a combination of software and hardware) and operable to communicate with the network (2530). More specifically, the interface (2504) may include software supporting one or more communication protocols associated with communications such that the network (2530) or interface's hardware is operable to communicate physical signals within and outside of the illustrated computer (2502).

The computer (2502) includes at least one computer processor (2505). Although illustrated as a single computer processor (2505) in FIG. 25, two or more processors may be used according to particular needs, desires, or particular implementations of the computer (2502). Generally, the computer processor (2505) executes instructions and manipulates data to perform the operations of the computer (2502) and any algorithms, methods, functions, processes, flows, and procedures as described in the instant disclosure.

The computer (2502) also includes a memory (2506) that holds data for the computer (2502) or other components (or a combination of both) that can be connected to the network (2530). For example, memory (2506) can be a database storing data consistent with this disclosure. Although illustrated as a single memory (2506) in FIG. 25, two or more memories may be used according to particular needs, desires, or particular implementations of the computer (2502) and the described functionality. While memory (2506) is illustrated as an integral component of the computer (2502), in alternative implementations, memory (2506) can be external to the computer (2502).

The application (2507) is an algorithmic software engine providing functionality according to particular needs, desires, or particular implementations of the computer (2502), particularly with respect to functionality described in this disclosure. For example, application (2507) can serve as one or more components, modules, applications, etc. Further, although illustrated as a single application (2507), the application (2507) may be implemented as multiple applications (2507) on the computer (2502). In addition, although illustrated as integral to the computer (2502), in alternative implementations, the application (2507) can be external to the computer (2502).

There may be any number of computers (2502) associated with, or external to, a computer system containing computer (2502), each computer (2502) communicating over network (2530). Further, the term “client,” “user,” and other appropriate terminology may be used interchangeably as appropriate without departing from the scope of this disclosure. Moreover, this disclosure contemplates that many users may use one computer (2502), or that one user may use multiple computers (2502).

In some embodiments, the computer (2502) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for reservoir simulation, the method comprising:
examining a knowledge graph logic associated with a reservoir simulation model for completeness,
wherein the knowledge graph logic comprises decision information that governs an execution of the reservoir simulation model;
making a determination, based on the examination, that the knowledge graph logic is incomplete;
based on the determination, generating an updated knowledge graph logic;
obtaining the decision information from the updated knowledge graph; and
executing the reservoir simulation model as instructed by the decision information.

2. The method of claim 1, wherein the examination of the knowledge graph logic for completeness is performed based on one selected from a group consisting of an ability to render statically accurate success failure decisions and an ability to render statistically accurate predictions, by the reservoir simulation model.

3. The method of claim 1, wherein the knowledge graph logic comprises knowledge graph logic for success and knowledge graph logic for failure.

4. The method of claim 1, wherein the reservoir simulation model is one selected from a group consisting of a classifier model and a regression model.

5. The method of claim 1, wherein generating the updated knowledge graph logic comprises:
executing, using a parameterization, the reservoir simulation model to reduce a misfit; and
when the execution of the reservoir simulation model fails to result in a reduction of the misfit, updating the knowledge graph logic with knowledge graph logic for failure, based on the parameterization.

6. The method of claim 5, wherein the parameterization is determined using a sensitivity analysis.

7. The method of claim 1, wherein generating the updated knowledge graph logic comprises:
executing, using a parameterization, the reservoir simulation model to reduce a misfit; and
when the execution of the reservoir simulation model results in a reduction of the misfit, updating the knowledge graph logic with knowledge graph logic for success, based on the parameterization.

8. The method of claim 7, wherein generating the updated knowledge graph logic further comprises:
performing simulation runs of the reservoir simulation model using stochastically sampled full parameter sets of the reservoir simulation model to identify a highest-ranked full parameter set of the reservoir simulation model; and
updating the knowledge graph logic with knowledge graph logic for success, based on the simulation runs.

9. The method of claim 8, wherein updating the knowledge graph logic based on the simulation runs comprises:
aggregating model parameters identified with the highest impact on model dynamic response; and
performing a refinement simulation run of the reservoir simulation model for the model parameters with the highest impact.

10. The method of claim 9, wherein updating the knowledge graph logic based on the simulation runs further comprises:
confirming that the misfit is reduced.

11. The method of claim 1, wherein the reservoir simulation model is for one selected from a group consisting of a history matching task and a field development planning task.

12. The method of claim 1, further comprising updating one selected from a group consisting of drilling parameters and production parameters based on a result of executing the reservoir simulation model.

13. A non-transitory machine-readable medium comprising a plurality of machine-readable instructions executed by one or more processors, the plurality of machine-readable instructions causing the one or more processors to perform operations comprising:
examining a knowledge graph logic associated with a reservoir simulation model for completeness,
wherein the knowledge graph logic comprises decision information that governs an execution of the reservoir simulation model;
making a determination, based on the examination, that the knowledge graph logic is incomplete;
based on the determination, generating an updated knowledge graph logic;
obtaining the decision information from the updated knowledge graph; and
executing the reservoir simulation model as instructed by the decision information.

14. The non-transitory machine-readable medium of claim 13, wherein the examination of the knowledge graph logic for completeness is performed based on one selected from a group consisting of an ability to render statically accurate success failure decisions and an ability to render statistically accurate predictions, by the reservoir simulation model.

15. The non-transitory machine-readable medium of claim 13, wherein generating the updated knowledge graph logic comprises:
executing, using a parameterization, the reservoir simulation model to reduce a misfit; and
when the execution of the reservoir simulation model fails to result in a reduction of the misfit, updating the knowledge graph logic with knowledge graph logic for failure, based on the parameterization.

16. The non-transitory machine-readable medium of claim 15, wherein the parameterization is determined using a sensitivity analysis.

17. The non-transitory machine-readable medium of claim 13, wherein generating the updated knowledge graph logic comprises:
executing, using a parameterization, the reservoir simulation model to reduce a misfit; and
when the execution of the reservoir simulation model results in a reduction of the misfit, updating the knowledge graph logic with knowledge graph logic for success, based on the parameterization.

18. The non-transitory machine-readable medium of claim 17, wherein generating the updated knowledge graph logic further comprises:
performing simulation runs of the reservoir simulation model using stochastically sampled full parameter sets of the reservoir model to identify a highest-ranked full parameter set of the reservoir simulation model; and
updating the knowledge graph logic with knowledge graph logic for success, based on the simulation runs.

19. The non-transitory machine-readable medium of claim 18, wherein updating the knowledge graph logic based on the simulation runs comprises:
aggregating model parameters identified with the highest impact on model dynamic response; and
performing a refinement simulation run of the reservoir simulation model for the model parameters with the highest impact.

20. The non-transitory machine-readable medium of claim 19, wherein updating the knowledge graph logic based on the simulation runs further comprises:
confirming that the misfit is reduced.
